(19) United States
(12) Patent Application Publication
(10) Pub. No.: US 2026/0265468 A1
(43) Pub. Date: Sep. 10, 2026

(54) COMPOSITIONS AND METHODS FOR COMPATIBILIZING POLYOLEFINS

(71) Applicant: RockyTech, Ltd., Boulder, CO (US)

(72) Inventor: Yinghua Jin, Boulder, CO (US)

(21) Appl. No.: 18/078,807

(22) Filed: Dec. 9, 2022

Related U.S. Application Data
(60) Provisional application No. 63/308,895, filed on Feb. 10, 2022.

(51) Int. Cl. C08J 3/24; B32B 7/12; B32B 27/08; B32B 27/32; C08F 8/42; C08J 5/12; C08L 23/06; C08L 23/12

(52) U.S. Cl. CPC C08J 3/246; B32B 7/12; B32B 27/08; B32B 27/32; C08F 8/42; C08J 5/12; C08L 23/06; C08L 23/12; B32B 2250/03; B32B 2250/24; B32B 2255/10; B32B 2255/24; C08F 2810/20; C08J 2323/06; C08J 2323/12; C08J 2423/12; C08J 2483/07

(57) ABSTRACT

Method for crosslinking polyolefins through incorporation of dynamic covalent bonds, including the use of radical initiators, silyl ether or siloxane containing functionalizing agents or crosslinkers, and diol or siloxane crosslinkers. Compatibilizer masterbatches may be obtained by mixing radical initiator, silyl ether or siloxane containing functionalizing agents or crosslinkers, diol or siloxane crosslinkers, and carrier plastic resins. Reactive processing methods of polyolefin crosslinking may include heat-pressing, compression molding, extrusion or other similar techniques. Compatibilizing and upcycling polyolefin blends may be achieved by applying the compatibilizer comprised of radical initiator, functionalizing agents, and crosslinking agents. The crosslinked polyolefins through dynamic covalent bonds may be reprocessed multiple times with minimal properties decrease with or without the addition of additional compatibilizers. The method may be configured for fabricating a fiber reinforced composite having specific desired material properties by combining with reinforcing fibers.

### RELATED APPLICATION

This application claims priority to U.S. Provisional Application 63/308,895 filed on Feb. 10, 2022, the content of which is incorporated herein by reference in its entireties for all purposes.

### STATEMENT REGARDING FEDERALLY FUNDED RESEARCH

This invention was made with government support under Grant No. DE-SC0021849, awarded by Department of Energy. The government has certain rights in the invention.

### BACKGROUND

Pollution from plastics represents a critical issue for our society today. Plastics are durable, lightweight, and available at low cost, bringing tremendous social benefits and technological advances. Therefore, plastics are very difficult to be replaced by other materials. Global production of polymer resins and fibers increased from 2 million metric tons in 1950 to 380 million metric tons in 2015. Only <10% of these polymers had been recycled as of 2015 in US, and ~79% of them, over 6000 million metric tons, ended up in landfills and natural environment.

Although plastic waste can be an important feedstock for the preparation of value-added materials, most plastic waste has been downcycled through mechanical methods or incineration with limited economic advantages.

Polyolefins, for example Polyethylene (PE), polypropylene (PP), and polystyrene (PS) are the most widely used thermoplastics, which constitute nearly 80% of plastic waste stream. All three main plastics PE, PP, PS, are thermodynamically immiscible, and their simple blends have poor mechanical performance.

The recycled plastics have already undergone thermo-mechanical degradation during their lifetime by the combined effect of humidity, UV light, chemical oxidation, and other environmental factors.

Most of these plastics can only be recycled once due to the severe degradation effects in multiphase polymeric systems.

To improve the performance of these recycled plastic mixtures and reclaim them as high-quality materials, various compatibilization strategies have been applied, including the use of premade or in situ generated block copolymers.

There remains a need for a rapid and cost-effective method for the upcycling of plastics, with the new plastics having similar or even enhanced mechanical properties than the pristine ones.

### SUMMARY

The present disclosure provides methods for rapid upcycling of polyolefins into malleable thermosets through dynamic covalent crosslinking, and related methods of use.

According to certain embodiments of the disclosure, incorporating dynamic covalent bonds into polyolefins through reactive compatibilization enables the crosslinking of linear chains (FIG. 1A). Polymer chain exchange through dynamic covalent bonds can proceed not only between identical polymer chains, but also between different incompatible polymer chains (FIG. 1B), thus achieving polymer fusion with minimal micro- and macroscopic phase separation.

In one embodiment, methods of incorporating cleavable covalent crosslinks (Si—O—Si, or Si—O—C) and transforming polyolefins into crosslinked polymers are provided. These crosslinked polyolefins are malleable and processible like common thermoplastics, but with high mechanical properties and creep resistance. The dynamic covalent crosslinks can be cleaved with an external trigger and the crosslinked polymers can be degraded to linear thermoplastic chains. Multiple times reprocessing and recycling is possible.

In one embodiment, the disclosure relates to reversibility and tunable kinetic profiles of siloxane (Si—O—Si) and silyl ether (Si—O—C) crosslinking bonds in the compatibilized polyolefins.

Reversible siloxane (Si—O—Si) and silyl ether (Si—O—C) linkages can enable polymer chain rearrangement and strong interface interactions between different polymer chains through silyl ether exchange, silyl ether metathesis, and siloxane exchange (FIG. 2).

In one aspect, the disclosure provides radical-mediated melt processing procedure (for example, extrusion or compression molding) to graft various readily available silyl ether or siloxane containing functionalizing agents into common polyolefins (PE, PP, PS). Such approaches offer several advantages which include but are not limited to the use of minimal amount of solvents, shorter reaction time, continuous process, and easier integration into existing infrastructure.

In some embodiments, a polyolefin composition comprising a first component, a second component and a third component is disclosed. In one aspect, the first component contains a polymer selected from the group consisting of one or more polyethylenes (PE), one or more polypropylenes (PP) and one or more polystyrenes (PS); In another aspect, the second component contains a polymer selected from the group consisting of one or more polyethylenes, one or more polypropylenes and one or more polystyrenes (PS). In another aspect, the third component is a covalent crosslink that connects the first component and the second component, and the covalent crosslink is selected from the group consisting of siloxane bond (Si—O—Si), silyl ether bond (Si—O—C) and combination thereof.

In some embodiments, the first component and the second component are different. In one aspect, the first component and the second component may contain different types of polymers. In one aspect, the first component may be one or more polyethylenes and the second component may be one or more polypropylenes or one or more polystyrenes. In another aspect, the first component may be one or more polypropylenes and the second component may be one or more polyethylenes or one or more polystyrenes. In another aspect, the first component may be one or more polystyrenes and the second component may be one or more polyethylenes or one or more polypropylenes.

In some embodiments, the first component and the second component are the same. In one aspect, the first component and the second component may contain the same type of polymer selected from the group consisting of polyethylenes (PE), polypropylenes (PP) and polystyrenes (PS). For example, the first component and the second component may be both PE, or both PP, or both PS.

In some embodiments, the silyl ether or siloxane bonds of the third component of the polyolefin composition may undergo dynamic bond exchange reactions within the same polymer chain or between different polymer chains of the first component or the second component.

In some embodiments, a multi-layer sheet is disclosed here which contains 3 or more layers: the first layer comprising polyethylene, the second layer comprising polypropylene and the third layer is adhesion layer. In one aspect, the adhesion layer is a thin layer comprising a covalent crosslink containing the siloxane bond (Si—O—Si), and/or the silyl ether bond (Si—O—C), which connect the polyethylene of the first layer and the polypropylene of the second layer. In another aspect, the adhesion layer is disposed between the first layer and the second layer, and is in direct contact with the first layer and the second layer. In some embodiments, the thickness of the adhesion layer is 0.5-10 μm (micrometer), 1-10 μm, 1-5 μm, 2-5 μm or about 2 μm.

In some embodiments, the polyethylene in the first layer is selected from the group consisting of: high density polyethylene (HDPE), low density polyethylene (LDPE), linear low-density polyethylene (LLDPE), ultra-high molecular weight polyethylene (UHMWPE), very low-density polyethylene (VLDPE), and polyethylene polyolefin block copolymer, and the polypropylene in the second layer is selected from the group consisting of: isotactic polypropylene (iPP), impact modified polypropylene, polypropylene fibers, and biaxially oriented polypropylene (BOPP).

In some embodiments, a method is disclosed for making a compatibilized polyolefin, which includes at least a step (a) and a step (b). In step (a), a polyolefin, a functionalizing agent and a radical initiator are mixed, and the polyolefin in the mixture is allowed to react with the functionalizing agent in the presence of the radical initiator to form a functionalized polyolefin. In step (b), a crosslinking agent is added to the functionalized polyolefin from step (a), allowing the functionalized polyolefin to react with the crosslinking agent to form the compatibilized polyolefin.

In one aspect, the temperatures at which step (a) and step (b) are conducted are the same. In another aspect, the temperatures at which step (a) and step (b) are conducted are different. In another aspect, the temperature at which step (a) is conducted is between 100° C. and 230° C., between 100° C. and 200° C., between 140° C. and 180° C., between 150° C. and 180° C., or between 180° C. and 200° C. or at about 170° C., or at about 180° C. In another aspect, when the temperature for step (a) is at 180° C., the reaction time is 1-3 min, or 2 min, or 3 min. In another aspect, when the temperature for step (a) is at 170° C., the reaction time is 8-12 min, or about 10 min. In another aspect, the temperature at which step (b) is conducted is between 100° C. and 230° C., between 100° C. and 200° C., between 140° C. and 180° C., between 150° C. and 180° C., between 180° C. and 200° C., or at about 170° C., or at about 180° C. In another aspect, when the temperature for step (b) is at 180° C., the reaction time is 1-3 min, or 2 min, or 3 min. In another aspect, when the temperature for step (b) is at 170° C., the reaction time is 5-12 min, or about 10 min.

In some embodiments, the polyolefin and the functionalizing agent are added to the reaction in step (a) at a ratio between 5:1 (w/w) and 200:1 (w/w), or at a ratio 100:1 (w/w), and wherein the functionalized polyolefin and the crosslinking agent are added to the reaction in step (b) at a ratio of between 5:1 (w/w) and 200:1 (w/w), or at 100:1 (w/w).

In one embodiment, a radical initiator is used in the disclosed process. In another embodiment, a functionalizing agent is used in the disclosed process. In another embodiment, one or more radical initiator and one or more functionalizing agent are used in the disclosed process. In one aspect, the functionalizing agent is selected from the group consisting of triethoxyvinylsilane (TEVS), trimethoxyvinylsilane, allyltriethoxysilane, allyltrimethoxysilane, tris(2-methoxyethoxy)(vinyl)silane, 3-(trimethoxysilyl)alkyl methacrylate, 3-(trimethoxysilyl)alkyl acrylate, 3-(triethoxysilyl)alkyl methacrylate, 3-(triethoxysilyl)alkyl acrylate, poly (ethylene glycol) silyl ether dimethacrylate (n=1-50), poly (ethylene glycol) silyl ether diacrylate (n=1-50), poly(ethylene glycol) methacrylate (n=1-50), poly(ethylene glycol) acrylate (n=1-50), 2,4,6,8-tetravinyl-2,4,6,8-tetramethylcyclotetrasiloxane, Vinyl-Terminated Polydimethylsiloxanes (Mn=150-80,000), Vinyl-Terminated Diphenylsiloxane-Dimethylsiloxane Copolymers (Mn=500-80,000), Vinyl-Terminated Polyphenylmethylsiloxane (Mn=500-80,000), Vinylphenylmethyl-Terminated Vinylphenylsiloxane-Phenylmethylsiloxane Copolymer (Mn=800-80,000), Vinyl-Terminated Trifluoropropylmethylsiloxane-Dimethylsiloxane Copolymers (Mn=500-80,000), Vinyl-Terminated Diethylsiloxane-Dimethylsiloxane Copolymers (Mn=500-80,000), Vinylmethylsiloxane-Dimethylsiloxane Copolymers (Mn=500-80,000), Vinylmethylsiloxane Homopolymers (Mn=500-80,000), Polydimethylsiloxane (Mn=150-80,000), Bis(divinyl)-Terminated, Vinylalkoxysiloxane Homopolymer (Mn=500-80,000), Methacryloxypropyl-Terminated Polydimethylsiloxanes (Mn=500-80,000), Methacryloxypropyl-Terminated Branched Polydimethylsiloxanes (Mn=500-80,000), (3-Acryloxy-2-hydroxypropoxypropyl) Terminated Poly Dimethylsiloxane (Mn=500-80,000), Acryloxy-Terminated Ethyleneoxide-Dimethylsiloxane-Ethyleneoxide ABA Block Copolymers (Mn=500-80,000), (Methacrylate/Acrylate)methylsiloxane-Dimethylsiloxane Copolymers (Mn=500-80,000), (3-Acryloxy-2-Hydroxypropoxypropyl)methylsiloxane-Dimethylsiloxane Copolymer (Mn=500-80,000), (Acryloxypropyl)methylsiloxane-Dimethylsiloxane Copolymers (Mn=500-80,000), (3-Acryloxy-2-Hydroxypropoxypropyl)methylsiloxane-Dimethylsiloxane Copolymer. (Mn=500-80,000).

In another aspect, the radical initiator is selected from the group consisting of dicumyl peroxide (DCP), benzoyl peroxide, 2,4-dichlorobenzoyl peroxide, 1,1′-[1,4-phenylenebis(1-methylethylidene)]bis[2-(1,1-dimethylethyl) peroxide], di-tert-butyl peroxide, tert-butyl cumyl peroxide, tert-butyl peroxybenzoate, Lauroyl peroxide, 2-butanone peroxide, di-tert-butyl peroxide 2,5-di(tert-butylperoxy)-2,5-dimethyl-3-hexyne, 2,5-bis(tert-butylperoxy)-2,5-dimethylhexane.

In another aspect, the crosslinking agent is selected from the group consisting of octamethylcyclotetrasiloxane, bis(heptamethylcyclotetrasiloxanyl)-ethane, aliphatic diol, polyvinyl alcohol (n=1-20), trimethylsiloxy-terminated Polydimethylsiloxanes (n=1-20), Alkyl-Terminated Polydimethylsiloxanes (Mn=150-80,000), trimethylsiloxane terminated methylhydrosiloxane-dimethylsiloxane copolymer (Mn=500-80,000), 1,2-Bis(trimethoxysilyl)alkane, Bis[3-(trimethoxysilyl)propyl]amine, Bis(3-(methylamino)propyl)trimethoxy silane.

In some embodiments, the functionalizing agent and the crosslinking agent are the same chemical and so step (a) and step (b) above take place at the same time at a temperature between 100C and 200C, between 100C and 140C, between 140C and 180C, between 150C and 180C, between 180° C. and 200° C., or at about 170C, or at about 180C. In another aspect, when the temperature for step (b) is at 180C, the reaction time is 1-3 min, or 2 min, or 3 min. In another aspect, when the temperature for step (b) is at 170C, the reaction time is 5-12 min, or about 10 min. Examples of chemicals that can act both as the functionalizing agent and the crosslinking agent include but are not limited to a siloxane and a silyl ether, wherein the silyl ether or siloxane contains two or more groups selected from the group consisting of a vinyl group, an acrylate group, and a methacrylate group. Specific examples of such chemicals include but are not limited to 2,4,6,8-Tetramethyl-2,4,6,8-tetravinylcyclotetrasiloxane (D4V), poly (ethylene glycol) silyl ether dimethacrylate (n=1-50), poly (ethylene glycol) silyl ether diacrylate (n=1-50), poly(ethylene glycol) methacrylate (n=1-50), poly(ethylene glycol) acrylate (n=1-50), Vinyl-Terminated Polydimethylsiloxanes (Mn=150-80,000), Vinyl-Terminated Diphenylsiloxane-Dimethylsiloxane Copolymers (Mn=500-80,000), Vinyl-Terminated Polyphenylmethylsiloxane (Mn=500-80,000), Vinylphenylmethyl-Terminated Vinylphenylsiloxane-Phenylmethylsiloxane Copolymer (Mn=800-80,000), Vinyl-Terminated Trifluoropropylmethylsiloxane-Dimethylsiloxane Copolymers (Mn=500-80,000), Vinyl-Terminated Diethylsiloxane-Dimethylsiloxane Copolymers (Mn=500-80,000), Vinylmethylsiloxane-Dimethylsiloxane Copolymers (Mn=500-80,000), Vinylmethylsiloxane Homopolymers (Mn=500-80,000), Polydimethylsiloxane (Mn=150-80,000), Bis(divinyl)-Terminated, Vinylalkoxysiloxane Homopolymer (Mn=500-80,000), Methacryloxypropyl-Terminated Polydimethylsiloxanes (Mn=500-80,000), Methacryloxypropyl-Terminated Branched Polydimethylsiloxanes (Mn=500-80,000), (3-Acryloxy-2-hydroxypropoxypropyl) Terminated PolyDimethylsiloxane (Mn=500-80,000), Acryloxy-Terminated Ethyleneoxide-Dimethylsiloxane-Ethyleneoxide ABA Block Copolymers (Mn=500-80,000), (Methacrylate/Acrylate)methylsiloxane-Dimethylsiloxane Copolymers (Mn=500-80,000), (3-Acryloxy-2-Hydroxypropoxypropyl)methylsiloxane-Dimethylsiloxane Copolymer (Mn=500-80,000), (Acryloxypropyl)methylsiloxane-Dimethylsiloxane Copolymers (Mn=500-80,000), (3-Acryloxy-2-Hydroxypropoxypropyl)methylsiloxane-Dimethylsiloxane Copolymer. (Mn=500-80,000).

In some embodiments, the radical initiators, the functionalizing agents and the crosslinkers are dispersed in a resin-based polymer to form a plurality of solid compatibilizer particles wherein the resin-based polymer acts as a solid carrier. In one aspect, the solid carrier is polymer resins (also referred to as “carrier resins”). In another aspect, the plurality of solid compatibilizer particles may be referred to as masterbatch in this disclosure. In one aspect, the plurality of solid compatibilizer particles is added to a plurality of solid polyolefin particles to form a mixture, which is then heated to a temperature 100° C. or above, or 100° C.-200° C., or 100° C.-150° C., or 100° C.-180° C. to form the compatibilized polyolefin. In some embodiments, the functionalizing agents and the crosslinkers are the same and the radical initiators and the functionalizing agents/crosslinkers are dispersed in a resin-based polymer to form a plurality of solid compatibilizer particles. In one aspect, the solid carrier is polymer resins (also referred to as “carrier resins”). In another aspect, the plurality of solid compatibilizer particles is added to solid polyolefin particles to form a mixture, said mixture being heated to a temperature 100° C. or above, or 100° C.-200° C., or 100° C.-150° C., or 100° C.-180° C. to form the compatibilized polyolefin.

In some embodiments, a compatibilizer composition containing a radical initiator, a functionalizing agent, and a crosslinking agent is disclosed. In one aspect, the radical initiator, the functionalizing agent, and the crosslinking agent constitute active ingredients of the compatibilizer composition and these active ingredients are dispersed in a solid carrier to form solid compatibilizer particles. In one aspect, the solid carrier is made of resin-based polymer. In some embodiment, the weight ratio between the active ingredients and the resin-based polymer is more than 30%, or more than 50%, or more than 90%, or more than 99%.

In some embodiments, the active ingredients, namely, the radical initiator, the functionalizing agent, and the crosslinking agent, differ from one another. In some embodiments, the functionalizing agent, and the crosslinking agent are the same chemical and is selected from the group consisting of a siloxane and a silyl ether, wherein the silyl ether or siloxane contains two or more groups selected from the group consisting of a vinyl group, an acrylate group, and a methacrylate group. Examples of such chemical that act as both a functionalizing agent and a crosslinking agent include but are not limited to 2,4,6,8-Tetramethyl-2,4,6,8-tetravinylcyclotetrasiloxane (D4V), poly (ethylene glycol) silyl ether dimethacrylate (n=1-50), poly (ethylene glycol) silyl ether diacrylate (n=1-50), poly(ethylene glycol) methacrylate (n=1-50), poly(ethylene glycol) acrylate (n=1-50), Vinyl-Terminated Poly dimethylsiloxanes (Mn=150-80,000), Vinyl-Terminated Diphenylsiloxane-Dimethylsiloxane Copolymers (Mn=500-80,000), Vinyl-Terminated Polyphenylmethylsiloxane (Mn=500-80,000), Vinylphenylmethyl-Terminated Vinylphenylsiloxane-Phenylmethylsiloxane Copolymer (Mn=800-80,000), Vinyl-Terminated Trifluoropropylmethylsiloxane-Dimethylsiloxane Copolymers (Mn=500-80,000), Vinyl-Terminated Diethylsiloxane-Dimethylsiloxane Copolymers (Mn=500-80,000), Vinylmethylsiloxane-Dimethylsiloxane Copolymers (Mn=500-80,000), Vinylmethylsiloxane Homopolymers (Mn=500-80,000), Polydimethylsiloxane (Mn=150-80,000), Bis(divinyl)-Terminated, Vinylalkoxysiloxane Homopolymer (Mn=500-80,000), Methacryloxypropyl-Terminated Polydimethylsiloxanes (Mn=500-80,000), Methacryloxypropyl-Terminated Branched Polydimethylsiloxanes (Mn=500-80,000), (3-Acryloxy-2-hydroxypropoxypropyl) Terminated Poly Dimethylsiloxane (Mn=500-80,000), Acryloxy-Terminated Ethyleneoxide-Dimethylsiloxane-Ethyleneoxide ABA Block Copolymers (Mn=500-80,000), (Methacrylate/Acrylate)methylsiloxane-Dimethylsiloxane Copolymers (Mn=500-80,000), (3-Acryloxy-2-Hydroxypropoxypropyl)methylsiloxane-Dimethylsiloxane Copolymer (Mn=500-80,000), (Acryloxypropyl)methylsiloxane-Dimethylsiloxane Copolymers (Mn=500-80,000), (3-Acryloxy-2-Hydroxypropoxypropyl)methylsiloxane-Dimethylsiloxane Copolymer. (Mn=500-80,000).

In some embodiments, examples of the radical initiator for the compatibilizer composition include but are not limited to dicumyl peroxide (DCP), benzoyl peroxide, 2,4-dichlorobenzoyl peroxide, 1,1′-[1,4-phenylenebis(1-methylethylidene)]bis[2-(1,1-dimethylethyl) peroxide], di-tert-butyl peroxide, tert-butyl cumyl peroxide, tert-butyl peroxybenzoate, Lauroyl peroxide, 2-butanone peroxide, di-tert-butyl peroxide 2,5-di(tert-butylperoxy)-2,5-dimethyl-3-hexyne, 2,5-bis(tert-butylperoxy)-2,5-dimethylhexane. In some embodiments, examples of the functionalizing agent for the compatibilizer composition include but are not limited to triethoxyvinylsilane, trimethoxyvinylsilane, allyltriethoxysilane, allyltrimethoxysilane, tris(2-methoxyethoxy)(vinyl)silane, 3-(trimethoxysilyl)alkyl methacrylate, 3-(trimethoxysilyl)alkyl acrylate, 3-(triethoxysilyl)alkyl methacrylate, 3-(triethoxysilyl)alkyl acrylate, poly (ethylene glycol) silyl ether dimethacrylate, poly (ethylene glycol) silyl ether diacrylate, poly(ethylene glycol) methacrylate, poly(ethylene glycol) acrylate, 2,4,6,8-tetravinyl-2,4,6,8-tetramethylcyclotetrasiloxane, Vinyl-Terminated Polydimethylsiloxanes, Vinyl-Terminated Diphenylsiloxane-Dimethylsiloxane Copolymers, Vinyl-Terminated Polyphenylmethylsiloxane, Vinylphenylmethyl-Terminated Vinylphenylsiloxane-Phenylmethylsiloxane Copolymer, Vinyl-Terminated Trifluoropropylmethylsiloxane-Dimethylsiloxane Copolymers, Diethylsiloxane-Dimethylsiloxane Copolymers (Vinyl-Terminated), Vinylmethylsiloxane-Dimethylsiloxane Copolymers, Vinylmethylsiloxane-Dimethylsiloxane Copolymers, Vinylmethylsiloxane Homopolymers, Polydimethylsiloxane, Bis(divinyl)-Terminated, Vinylalkoxysiloxane Homopolymer, Methacryloxypropyl-Terminated Polydimethylsiloxanes, Methacryloxypropyl-Terminated Branched Polydimethylsiloxanes, (3-Acryloxy-2-hydroxypropoxypropyl) Terminated PolyDimethylsiloxane, Acryloxy-Terminated Ethyleneoxide-Dimethylsiloxane-Ethyleneoxide ABA Block Copolymers, (Methacrylate/Acrylate)methylsiloxane-Dimethylsiloxane Copolymers, (3-Acryloxy-2-Hydroxypropoxypropyl)methylsiloxane-Dimethylsiloxane Copolymer, (Acryloxypropyl)methylsiloxane-Dimethylsiloxane Copolymers, (3-Acryloxy-2-Hydroxypropoxypropyl)methylsiloxane-Dimethylsiloxane Copolymer. In some embodiments, examples of the crosslinking agent for the compatibilizer composition include but are not limited to octamethylcyclotetrasiloxane, bis(heptamethylcyclotetrasiloxanyl)-ethane, aliphatic diol, polyvinyl alcohol, trimethylsiloxy-terminated Polydimethylsiloxanes, Alkyl-Terminated Poly dimethylsiloxanes, trimethyldiloxane terminated methylhydrosiloxane-dimethylsiloxane copolymer, 1,2-Bis(trimethoxysilyl)alkane, Bis[3-(trimethoxysilyl)propyl]amine, Bis(3-(methylamino)propyl)trimethoxysilane.

In some embodiments, the resin-based polymer contains one or more additives. Examples of the one or more additives may include UV-stabilizers (for example, carbon black, benzotriazoles, hydroxy-phenyltriazines), antistatic agents (for example, quaternary ammonium salts, aliphatic amines, phosphate esters, and ethylene glycols), anti-slip agents (for example, aluminium oxide, silica, crushed glass, long-chain fatty acid amides), antiblock (for example, silica or talc), impact modifiers (for example, impact modifier resins), processing aids (for example, metal soaps, hydrocarbon waxes, amide waxes, fatty acids, fatty alcohols and esters, and fluoropolymers), and melt strength enhancers (for example, acrylic melt strength enhancer).

In some embodiments, the disclosure relates to the use of peroxides as radical initiators and vinyl or acrylate, or methacrylate containing silyl ethers and siloxanes as the functionalizing agents that can be efficiently grafted onto polyolefins through radical reaction. The thermal decomposition of the radical initiator, for example, dicumyl peroxide (DCP), forms radical species, which preferentially abstract hydrogen from C-C chains to produce macroradicals. The macroradicals add to the vinyl or acrylate, or methacrylate containing molecules and the grafting occurs. One of the advantages of using vinyltrialkoxysilanes as a functionalizing agent is that they do not easily homopolymerize due to the bulky side groups. In addition, these monomers have low toxicity and volatility compared to previously demonstrated maleic anhydride, which is corrosive, volatile, and toxic.

In another aspect, the disclosure provides grafting procedures of the above-mentioned functionalizing agents to single type polyolefins, including but not limited to high density polyethylenes (HDPE), low density polyethylene (LDPE) polypropylene (PP), and polystyrene (PS). Grafting of the functional monomers can install silyl ether or siloxane groups for reversible silyl ether or siloxane crosslinking bonds formation.

In another aspect, the disclosure provides the grafting procedures of polymer blends of various compositions of PE, PP, and PS. The amount of a single type of plastic in the composition according to the invention may vary from 3 wt. % to 97 wt. %. The functionalization density of every polymer type in the blends may be tuned by adjusting reaction temperature, residence time, mixing speed, peroxide type and amount.

In another aspect, the disclosure relates to crosslinking of single component functionalized polyolefins through a reaction with crosslinkers, wherein the crosslinkers are silyl ethers, siloxanes and diols with different lengths, flexibilities, and reactivities (examples are shown in FIGS. 3A-B). The crosslinkers react with silyl ether or siloxane groups on the polymer chains through silyl ether or siloxane exchange or metathesis reactions. Volatile small molecule byproduct (e.g., methanol, methoxytrimethysilane) may be formed during the silyl ether formation in the system in a small amount (<0.5 wt %).

In another aspect, the disclosure relates to crosslinking of functionalized polyolefin blends through reaction with crosslinkers, wherein the crosslinkers are silyl ethers, siloxanes and diols with different lengths, flexibilities, and reactivities. Examples of crosslinkers are shown in FIGS. 3A-B. The crosslinkers react with silyl ether or siloxane groups on the polymer chains through silyl ether or siloxane exchange or metathesis reactions. Volatile small molecule byproduct (e.g., methanol, methoxytrimethysilane) may be formed during the silyl ether formation in the system in a very small amount (<0.5 wt %).

In another aspect, the disclosure relates to crosslinking of functionalized polymer blends through silyl ether/siloxane exchange/metathesis reactions. This may bring strong interface adhesion between different type of polymer chains and overall morphology stabilization. Some of the advantages of crosslinking thermoplastic polymers include easy processing, low cost, and favorable properties in the processed materials, such as heat resistance and improved adhesion.

In another aspect, the invention provides a compatibilization method using a peroxide initiator and functional crosslinkers for polyolefins, wherein polyolefins are one or more types of PP, PE, and PS in different forms. The amount of compatibilizer is from 1-10 wt % based on the total amount of the composition.

In one embodiment, the disclosure involves compatibilization technology for polyolefin blends through covalent crosslinking of the polymer chains. The compatibilization of polyolefin blends can be accomplished in two main synthetic approaches depending on the structures of functionalizing agents and crosslinkers. In method A, Polyolefins react with a functionalizing agent, such as triethoxyvinylsilane (TEVS, FIG. 3B) in the presence of a radical initiator, for example DCP, at a predetermined ratio to form functionalized polyolefins. The functionalized polyolefins further react with crosslinking agents, for example, a diol, at a predetermined ratio to form compatibilized polyolefins. In method B, functionalizing agents with multiple reactive groups, for example, D4V (FIG. 3B), or vinyl terminated polydimethylsiloxanes (FIG. 3B), could be used as both functionalizing agents and crosslinkers. In method B, the compatibilization of polyolefin blends can be accomplished in a single step.

In another embodiment, a mixture of a radical initiator and a reactive multi-vinyl, multi-acrylate, or multi-methacrylate substituted silyl ether or siloxanes can be used as a polyolefin compatibilizer (FIG. 3B). The weight ratio of the radical initiator and the reactive crosslinker is in the range of between 1:10 and 1:20, or at about 1:12, or at about 1:14, or at about 1:15, or at about 1:16, or at about 1:18.

In some embodiments, the disclosure relates to upcycling of a bulk mixture of polyolefin blends using compatibilizer composition described in certain embodiments through reactive processing methods, including heat-pressing, compression molding, extrusion, or other similar techniques. The polyolefin blends may be one or more types of PE, PP, and PS. In other words, the polyolefin blends can contain a single type, for example PE only, PP only or PS only, or it can contain two or three types selected from the group consisting of PE, PP and PS.

In some embodiments, disclosed here is a multi-layer sheet comprising two or more types of polyolefin films and a compatibilizer in between the two or more types of polyolefin films. In one aspect, the compatibilizer acts as an adhesive that glues the two or more types of polyolefin films together. For example, a multi-layer sheet may contain a PE film and a PP film and a compatibilizer that is positioned between the PE film and the PP film, wherein the compatibilizer is in direct contact with both the PE and PP films.

In some embodiments, the invention relates to laminating multi-layer of polyolefins using a compatibilizer in between each layer, for example incompatible PE film and PP film can be glued together with compatibilizer composition.

In some embodiments, the compatibilized polyolefin is further subject to extrusion or molding to form different solid forms of compatibilized polyolefin. In one aspect, disclosed here is a method of reusing plastics by converting recycled plastics into a compatibilized polyolefin composition described herein. In another aspect, the compatibilized polyolefin obtained according to the instant disclosure can be made into different products.

The above embodiments may solve the degradation problem of recycled plastics. When polyolefin blends are crosslinked through dynamic covalent bonds, the dynamic nature of the crosslinks may enable fast stress relaxation and dissipation of the elastic energy and thus minimize the scission of C-C bonds and degradation. These crosslinked polyolefins containing silyl ether or siloxane bonds may undergo dynamic bond exchange reactions and rearrangement of polymer chain connectivity to adapt to the external stimuli (heat and pressure here) by releasing the stress.

The above embodiments improve polyolefin recycling by reducing some sorting steps. Low grade mixed polyolefins can be upcycled into high grade plastics through strong covalent linking of polymer chains rather than traditional physical inter-diffusion and entanglement. Efficient upcycling of common polyolefin blends in a waste stream may be achieved.

Features and steps from any of the disclosed embodiments may be used in combination with one another, without limitation. For example, any of the compositional limitations described with respect to one embodiment may be present in any of the other described embodiments. In addition, other features and advantages of the present disclosure will become apparent to those of ordinary skill in the art through consideration of the following detailed description and the accompanying drawings.

### BRIEF DESCRIPTION OF THE DRAWINGS

FIGS. 1A-1B show a schematic of polymer fusion process through dynamic bond exchange reactions between polymer chains according to an embodiment of the disclosure.

FIG. 2 shows the possible dynamic reactions involving Si—O bonds.

FIG. 3A shows a schematic of two methods (Method A and Method B) of polyolefin functionalization and crosslinking. FIG. 3B shows the representative structures of functionalizing agents, radical initiators, and crosslinkers.

FIG. 4A shows the reaction of PS, dicumyl peroxide (DCP), and 2,4,6,8-tetravinyl-2,4,6,8-tetramethylcyclotetrasiloxane (D4V) to form crosslinked PS. FIG. 4B shows the nuclear magnetic resonance (NMR) spectra of the mixture right after mixing and after heating at 180° C. for 20 min. FIG. 4C shows the Infrared (IR) spectra of PS, DCP, D4V, and PS after crosslinking (Crosslinked-PS) and the insoluble fraction after soaking the crosslinked-PS in CDCl₃ for 15 hours.

FIG. 5A shows the reaction of PS, DCP, and triethoxyvinylsilane (TEVS) to form functionalized linear PS, and subsequent crosslinking to form crosslinked PS. FIG. 5B shows IR spectra of functionalized PS, 1,6-hexanediol, as-synthesized crosslinked PS, and insoluble species obtained after soaking the as-synthesized crosslinked PS in toluene. FIG. 5C shows IR spectra of three samples obtained after heat pressing the insoluble species described in FIG. 5b.

FIGS. 6A and 6C show scanning electron microscope (SEM) images of the cross section of commercial PE and PP bulk films with an embodiment of compatibilizer mixture between the two films. FIGS. 6B and 6D show scanning electron microscope (SEM) images of the cross section of commercial PE and PP bulk films without an embodiment of compatibilizer mixture between the two films. FIG. 6E shows an SEM image of the fracture surface of the 70:30 weight ratio of commercial PE and PP blends with an embodiment of compatibilizer mixture. The sample was prepared through twin-screw extrusion. FIG. 6F shows an SEM image of the fracture surface of the 70:30 weight ratio of commercial PE and PP blends without an embodiment of compatibilizer mixture. The sample was prepared through twin-screw extrusion.

FIG. 7 shows stress-strain curves of polyolefin films prepared from a mixture of commercial PE and PP in a 50:50 weight ratio with and without an embodiment of compatibilizer mixture. The stress-strain curves of commercial PE and PP films are also shown for comparison reasons. All the samples were prepared through heat press of plastic particles with or without an embodiment of compatibilizer mixture.

FIG. 8 shows stress-strain curves of polyolefin films prepared from a mixture of commercial PE and PP in a 70:30 weight ratio with and without an embodiment of compatibilizer solution. The stress-strain curves of commercial PE and PP films are also shown for comparison reasons. All the samples were prepared through heat press of plastic particles with or without an embodiment of compatibilizer mixture.

FIG. 9 shows stress-strain curves of polyolefin films prepared from a mixture of commercial PE and PP in a 70:30 weight ratio with (control sample) and without an embodiment of compatibilizer mixture. The stress-strain curves of commercial PE and PP films are also shown for comparison reasons. All the samples were prepared through twin screw extrusion process of plastic resins with or without an embodiment of compatibilizer mixture.

The drawings are included to provide a better understanding of the invention, and are not intended to be limiting in scope, but to provide exemplary illustrations.

### DETAILED DESCRIPTION

It is to be understood that the disclosure is not limited to the specific embodiments and methods described below, as specific components and/or conditions may vary. Furthermore, the terminology used herein is used only for the purpose of describing particular embodiments and is not intended to be limiting in any way.

Except in the examples, or where otherwise expressly indicated, all numerical quantities in this description indicating amounts of material or conditions of reaction and/or use are to be understood as modified by the word “about” in describing the broadest scope of the disclosure. Also, unless expressly stated to the contrary: description of constituents in chemical terms refers to the constituents at the time of addition to any combination specified in the description, and does not necessarily preclude chemical interactions among the constituents of a mixture once mixed; the first definition of an acronym or other abbreviation applies to all subsequent uses herein of the same abbreviation; and, unless expressly stated to the contrary, measurement of a property is determined by the same technique as previously or later referenced for the same property.

It must also be noted that, as used in the specification and the appended claims, the singular form “a,” “an,” and “the” may comprise plural references unless the context clearly indicates otherwise. For example, reference to a component in the singular is intended to comprise a plurality of components.

Unless otherwise specified, the ratio and percentage disclosed herein are by weight.

Polyethylene (PE) in the composition may include but is not limited to a very low-density polyethylene (VLDPE), linear low-density polyethylene (LLDPE), low density polyethylene (LDPE), medium density polyethylene (MDPE), high density polyethylene (HDPE), and mixtures thereof. For example, the polyethylene may be a mixture of HDPE and MDPE or it may be a mixture of two different types of HDPE.

Polypropylene (PP) in the composition may include but is not limited to homopolymer polypropylene, block copolymer polypropylene containing ethylene anywhere between 5% to 15%, random co-polymer propylene containing random patterns of ethylene in anywhere between 1% and 7%, and mixtures thereof.

Embodiments of the present disclosure provide methods for compatibilizing polyolefins in different composition and forms. The disclosed method for compatibilizing otherwise immiscible polyolefins may result in upcycling of discarded low value polyolefin mixtures to valuable secondary materials that can substitute virgin polymers or a portion of virgin polymers, thus conserving our limited stock of oil and gas supply, reducing the accumulation of plastic wastes in the environment, and increasing chemical circularity. Embodiments of the disclosure include resulting polyolefin products, compatibilizers, and related processes and methods of use.

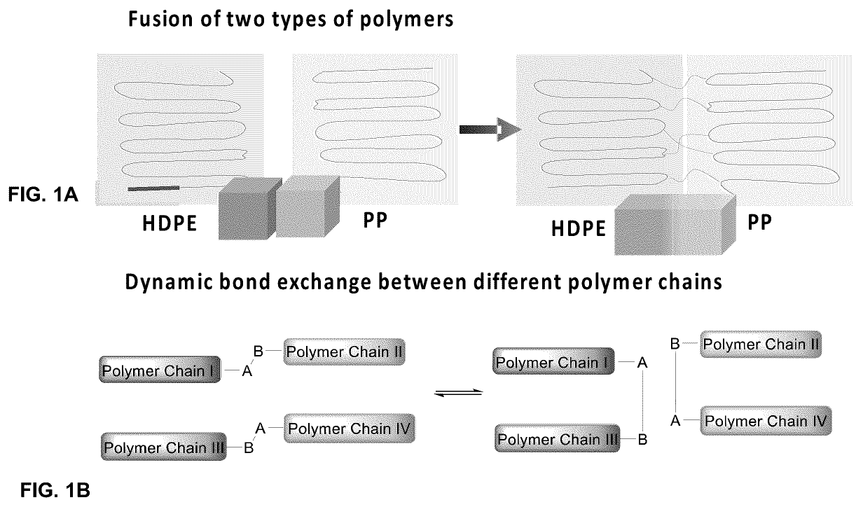

Referring now to FIG. 1a, a method of forming crosslinked polymer blends according to an embodiment of the disclosure is shown schematically. The method may include providing crosslinking agents as part of compatibilizers. An elevated temperature and an elevated pressure may be applied to polyolefins for reactive compatibilization through crosslinking. The method may enable strong “non-permanent” covalent linking of polyolefin chains rather than physical inter-diffusion and entanglement and can solve the immiscibility issues. Covalent crosslinking between polymer chains may macroscopically enhance the interfacial adhesion and long-term stabilization of the blend morphology. Formation of network polymers may enhance the mechanical properties and thermal/chemical stabilities, which can compensate for deterioration in recycled plastics performance due to the degradation.

Referring now to FIG. 1b, polymer chain exchange through dynamic covalent bonds can proceed not only between identical polymer chains, but also between different incompatible polymer chains. Dynamic covalent crosslinking between polymer chains produces a favorable mixing enthalpy that can lead to complete miscibility with minimal micro- and macroscopic phase separation. The covalent interactions between polymer blends are much stronger than noncovalent supramolecular interactions, yet they are still reversible under external stimuli (e.g., heat). The stabilization of blend morphology by strong dynamic bond interactions prevents gross phase segregation and delamination on a macroscopic scale by increasing the kinetic barrier.

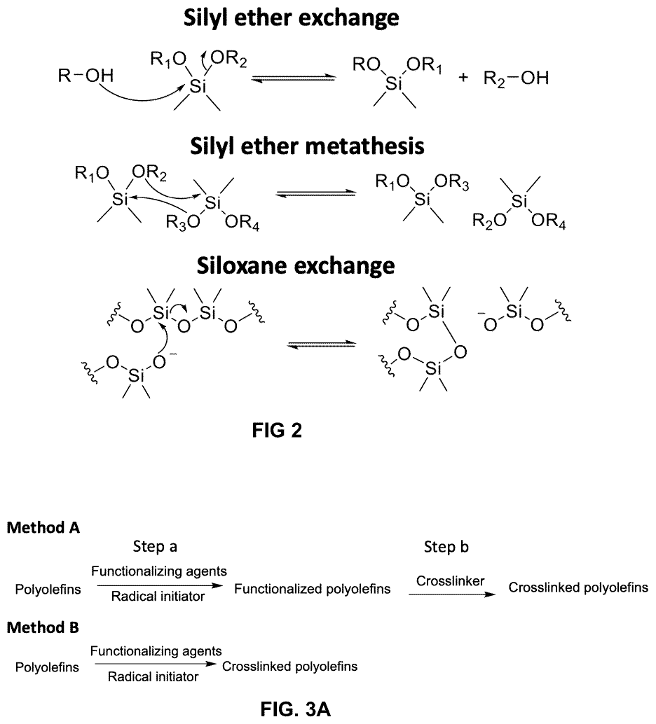

Referring now to FIG. 2, siloxane (Si—O—Si) and silyl ether (Si—O—C) linkages introduced in polyolefins can be reversible under the melt-processing conditions described in certain embodiments, for example, extrusion, heat-pressing, or compression molding. The mechanism of the bond exchange of siloxane (Si—O—Si) and silyl ether (Si—O—C) linkages can be silyl ether exchange, silyl ether metathesis, or siloxane exchange. The term “dynamic bond exchange” refers to this exchange of Si—O bonds in polymer materials which may enable polymer chain shuffling, stress relaxation, self-healing properties, and further upcycling of recycled polyolefins.

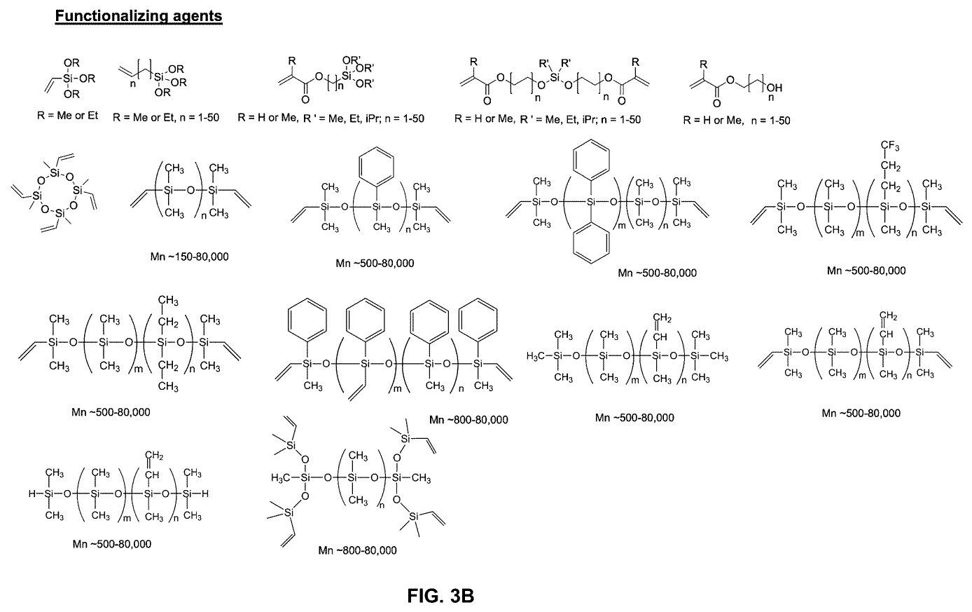

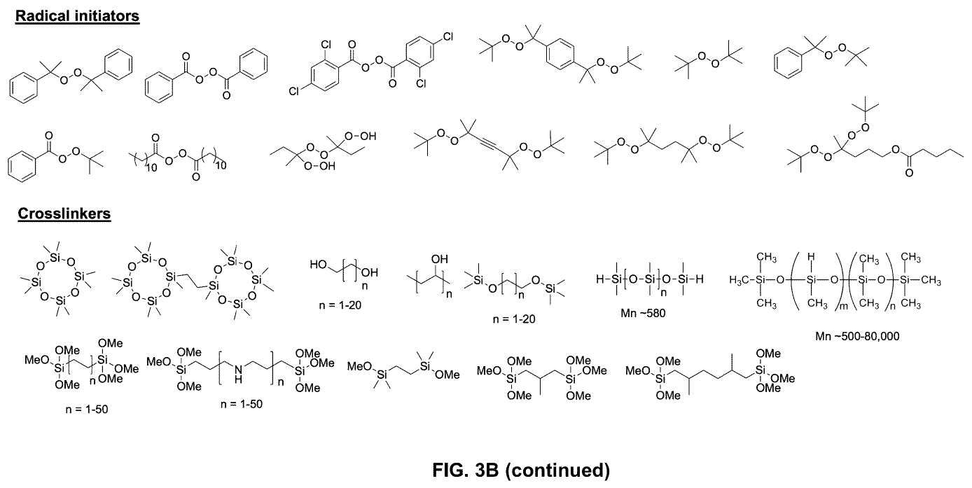

In the illustrated reaction scheme in FIG. 3A, in method A, polyolefins may be reacted with functionalizing agents, such as triethoxyvinylsilane (TEVS) in the presence of radical initiators, such as dicumyl peroxide (DCP), at a predetermined ratio to form functionalized polyolefins. The functionalized polyolefins can further react with crosslinking agents, such as a diol at a predetermined ratio to form crosslinked polyolefins. The reaction may proceed in solution or without any solvent added. High temperature and pressure may be applied. Extrusion or compression molding may be suitable for the reactions. Various polyolefins, peroxide initiators, functionalizing agents, and crosslinkers listed in FIG. 3B may be selected and used at a varying ratio based on the desired material properties of crosslinked polyolefins. Polystyrene (PS) may be preferred in some embodiments due to its good solubility in various organic solvents so that the chemical compositions of products can be more precisely characterized.

In some embodiments, functionalizing agents may have multiple reactive groups, such as D4V, and may serve as both functionalizing agents and crosslinkers. In that case, Method B in FIG. 3A. may be used and the crosslinking of polyolefins may be accomplished in a single step.

Extrusion, heat-pressing, or compression molding may be suitable for the reactions in Method A and Method B in FIG. 3A. Ratios of polyolefins, initiators and functionalizing agents may vary depending on the type of polyolefins, components of polyolefin blends, and the desired material properties of crosslinked polymer blends. Polyolefin composition may comprise one or more polyethylenes, one or more polypropylenes, one or more polystyrenes, a blend of two or more different types of polyolefins. According to various embodiments, the polyolefins may be in the forms of pellets, powder, or films. In one example, the polyolefins may be provided as a powder and compression molded with initiator, functionalizing agents, and crosslinkers.

The mechanical properties of crosslinked polyolefin blends may be advantageously controlled by the mass ratio of initiator, functionalizing agents, and crosslinkers added during reactive processing. Initiator, functionalizing agents, and crosslinkers may be added sequentially and their mass fractions may be changed. In varying examples of the disclosure, the combined mass of initiator, functional monomer, and crosslinkers may be 1-15%, 2-12%, 5-10%, or 8-10%, or about 10%, or about 15% by weight of the total mass of polyolefins.

The reactions may occur through extrusion or compression molding method to graft pendant reactive groups onto polyolefins. The reaction temperature, time, the amount of free-radical initiator, functional group density, and overall viscosity may be tuned to obtain optimal conditions to ensure grafting efficiency and to minimize free unreacted monomers and macromolecular radical recombination. Crosslinkers may be introduced together with initiator and functionalizing agents, or in a separate step after obtaining functionalized polyolefins to crosslink functionalized polyolefins. Crosslinking step may also proceed through extrusion or compression molding. According to variations of the reactive processing, polyolefins, initiators, functionalizing agents, and crosslinkers may be heated, compressed, and extruded using a heated press, a compression mold, extruder, or using similar devices as would be recognized by one of ordinary skill in the art informed by the present disclosure.

In some embodiments, the selection of reaction temperature, residence time, mixing speed in extrusion or compression molding is critical for realizing the advantages of some embodiments. In extrusion or compression molding, the processing temperature may be more critical for recycling of mixed plastics with different melting points. It may set to be as high as necessary to process the polyolefin with the highest melting point, but not too high to cause significant polymer degradation. Higher mixing speed or longer mixing time can result in adequate mixing but at the same time may cause mechanical degradation of polyolefins. The processing temperature may be in the range of 100-140° C., 140-200° C., 160° C.- 200° C., or 180° C.-200° C. The residence time may be in the range of 1 min-15 min, 2-12 min, or 4-8 min. The mixing speed may be in the range of 40 rpm-150 rpm, or 60 rpm to 120 rpm, or 80 rpm-100 rpm. In some embodiments, the parameters of the reactions include processing temperature 140-200° C., residence time from 1 min to 15 min and mixing speed 40 rpm-150 rpm. In some embodiments, the parameters of the reactions include processing temperature 160-200° C., residence time from 4 min to 8 min and mixing speed 60 rpm-120 rpm.

In some embodiments, the premixed functionalizing agent and initiator may be directly used as a compatibilizer of polyolefins. In an embodiment, the compatibilizer according to the invention may be obtained by mixing the functionalizing agent with initiator before adding it to polyolefins. 1-15% of compatibilizer may be added during the compatibilization of polyolefin blends.

In some embodiments, a compatibilizer masterbatch may be prepared by melt mixing masterbatch carriers with the compatibilizer. The amount of compatibilizer added to the master batch may be 10-99%.

In some embodiments, the crosslinked polyolefins containing dynamic Si—O bonds may be reprocessed multiple times. Reprocessing of polymer blends often causes significant decrease in their mechanical properties due to the thermal and mechanical degradation, which is accompanied by changes in molecular weight, molecular weight distribution, and cross-linking. Recycled plastics are more sensitive to degradation and multiple cycles of reprocessing lead to materials failure. When plastic blends are crosslinked by dynamic covalent bonds, it is expected that the dynamic nature of the crosslinks enables fast stress relaxation and dissipation of the elastic energy and thus minimize the scission of C—C bonds and properties degradation. Under applied pressure and elevated temperature, dynamic bonds undergo exchange reactions and rearrangement of polymer chain connectivity to adapt to the external heat and pressure here by releasing the stress. The crosslinked polyolefin blends by dynamic covalent bonds may be repeatedly reprocessed without losing their mechanical properties.

The disclosed methods may be applied to post-consumer or post-industrial waste plastics containing PP, PE, and PS. In some embodiments, the crosslinked recycled polyolefins prepared according to this disclosure show a 110-200%, or at least 120%, at least 150%, or at least 180% or about 200% increase in mechanical properties as compared to those polyolefins not subject to the crosslinking process of the instant disclosure. In some embodiments, the crosslinked recycled polyolefins prepared according to this disclosure show a 110-200%, or at least 120%, at least 150%, or at least 180% or about 200% increase in creep resistance as compared to those polyolefins not subject to the crosslinking process of the instant disclosure. In some embodiments, the crosslinked recycled polyolefins prepared according to this disclosure show a 110-200%, or at least 120%, at least 150%, or at least 180% or about 200% increase in melt strength as compared to those polyolefins not subject to the crosslinking process of the instant disclosure. In some embodiments, the crosslinked recycled polyolefins prepared according to this disclosure show a 110-200%, or at least 120%, at least 150%, or at least 180% or about 200% increase in dimensional, chemical, and thermal stabilities as compared to those polyolefins not subject to the crosslinking process of the instant disclosure. Examples of mechanical properties include but are not limited to tensile strength, tensile modulus, impact strength, flexural strength, and modulus. Si—O bonds may be cleaved by a chemical method to convert the crosslinked polyolefins back to linear polymers.

In an embodiment, the crosslinked polyolefins may be combined with various forms of reinforcing additives for example, talc, clay, carbon fibers, and natural fibers (hemp, flex etc.), glass fibers, or other additives for example flame retardants, surface modifiers, dyes, pigments, and mold releasing agents. The amount of reinforcing additives may be 20-70% and the amount of other additives may preferably <5%. Such additions, modifications, and arrangements will be apparent to a person skilled in the art from the underlying invention.

The present disclosure may be further illustrated by the following Items:

Item 1: A polyolefin composition comprising a first component, a second component and a third component,
the first component comprising a polymer selected from the group consisting of one or more polyethylenes (PE), one or more polypropylenes (PP) and one or more polystyrenes (PS),
the second component comprising a polymer selected from the group consisting of one or more polyethylenes, one or more polypropylenes and one or more polystyrenes (PS), and
the third component being a covalent crosslink,
   wherein said covalent crosslink connects the first component and the second component, and said covalent crosslink is selected from the group consisting of siloxane bond (Si—O—Si), silyl ether bond (Si—O—C) and combination thereof.

Item 2: The polyolefin composition of Item 1, wherein the percentage of polymers in the first component and the second component that are linked by said covalent crosslink is between 5% and 50%, between 5% and 40%, between 10% and 30%, or between 20% and 30%.

Item 3: The polyolefin composition of any preceding Items, wherein the first component and the second component are different, the first component being one or more polyethylenes and the second component being selected from the group consisting of one or more polypropylenes and one or more polystyrenes.

Item 4: The polyolefin composition of Items 1-2, wherein the first component and the second component are different, the first component being one or more polypropylenes and the second component being selected from the group consisting of one or more polyethylenes and one or more polystyrenes.

Item 5: The polyolefin composition of Items 1-2, wherein the first component and the second component comprise the same type of polymer selected from the group consisting of polyethylenes (PE), polypropylenes (PP) and polystyrenes (PS).

Item 6: The polyolefin composition of any preceding Items, wherein the silyl ether or siloxane bonds undergo dynamic bond exchange reactions within the same polymer chain or between different polymer chains of the first component or the second component.

Item 7: A multi-layer sheet comprising
a first layer comprising polyethylene;
a second layer comprising polypropylene; and
a third layer, wherein the third layer is an adhesion layer comprising a covalent crosslink connecting the polyethylene of the first layer and the polypropylene of the second layer, said covalent crosslink being selected from the group consisting of siloxane bond (Si—O—Si), silyl ether bond (Si—O—C) and combination thereof,
wherein the adhesion layer is disposed between the first layer and the second layer, and is in direct contact with the first layer and the second layer.

Item 8: The multi-layer sheet according to Item 7, wherein the polyethylene in the first layer is selected from the group consisting of: high density polyethylene (HDPE), low density polyethylene (LDPE), linear low-density polyethylene (LLDPE), ultra-high molecular weight polyethylene (UHMWPE), very low-density polyethylene (VLDPE), and polyethylene polyolefin block copolymer, and wherein the polypropylene in the second layer is selected from the group consisting of: isotactic polypropylene (iPP), impact modified polypropylene, polypropylene fibers, and biaxially oriented polypropylene (BOPP).

Item 9: The multi-layer sheet according to any of Items 7-8, wherein the adhesion layer is 0.5-10 μm (micrometer) thick.

Item 10: A method for making a compatibilized polyolefin, comprising
a) mixing a polyolefin with a functionalizing agent and a radical initiator, allowing the polyolefin to react with the functionalizing agent in the presence of the radical initiator to form a functionalized polyolefin, and
b) adding a crosslinking agent to the functionalized polyolefin from step (a), allowing the functionalized polyolefin to react with the crosslinking agent to form the compatibilized polyolefin.

Item 11: The method of Item 10, wherein the polyolefin and the functionalizing agent are added to the reaction in step (a) at a ratio between 5:1 (w/w) and 200:1 (w/w), and wherein the functionalized polyolefin and the crosslinking agent are added to the reaction in step (b) at a ratio of between 5:1 (w/w) and 200:1 (w/w).

Item 12: The method of any of Items 10-11, wherein the functionalizing agent is selected from the group consisting of triethoxyvinylsilane (TEVS), trimethoxyvinylsilane, allyltriethoxysilane, allyltrimethoxysilane, tris(2-methoxyethoxy)(vinyl)silane, 3-(trimethoxysilyl)alkyl methacrylate, 3-(trimethoxysilyl)alkyl acrylate, 3-(triethoxysilyl)alkyl methacrylate, 3-(triethoxysilyl)alkyl acrylate, poly (ethylene glycol) silyl ether dimethacrylate (n=1-50), poly (ethylene glycol) silyl ether diacrylate (n=1-50), poly(ethylene glycol) methacrylate (n=1-50), poly(ethylene glycol) acrylate (n=1-50), 2,4,6,8-tetravinyl-2,4,6,8-tetramethylcyclotetrasiloxane, Vinyl-Terminated Polydimethylsiloxanes (Mn=150-80,000), Vinyl-Terminated Diphenylsiloxane-Dimethylsiloxane Copolymers (Mn=500-80,000), Vinyl-Terminated Polyphenylmethylsiloxane (Mn=500-80,000), Vinylphenylmethyl-Terminated Vinylphenylsiloxane-Phenylmethylsiloxane Copolymer (Mn=800-80,000), Vinyl-Terminated Trifluoropropylmethylsiloxane-Dimethylsiloxane Copolymers (Mn=500-80,000), Vinyl-Terminated Diethylsiloxane-Dimethylsiloxane Copolymers (Mn=500-80,000), Vinylmethylsiloxane-Dimethylsiloxane Copolymers (Mn=500-80,000), Vinylmethylsiloxane Homopolymers (Mn=500-80,000), Polydimethylsiloxane (Mn=150-80,000), Bis(divinyl)-Terminated, Vinylalkoxysiloxane Homopolymer (Mn=500-80,000), Methacryloxypropyl-Terminated Polydimethylsiloxanes (Mn=500-80,000), Methacryloxypropyl-Terminated Branched Polydimethylsiloxanes (Mn=500-80,000), (3-Acryloxy-2-hydroxypropoxypropyl) Terminated Poly Dimethylsiloxane (Mn=500-80,000), Acryloxy-Terminated Ethyleneoxide-Dimethylsiloxane-Ethyleneoxide ABA Block Copolymers (Mn=500-80,000), (Methacrylate/Acrylate)methylsiloxane-Dimethylsiloxane Copolymers (Mn=500-80,000), (3-Acryloxy-2-Hydroxypropoxypropyl)methylsiloxane-Dimethylsiloxane Copolymer (Mn=500-80,000), (Acryloxypropyl)methylsiloxane-Dimethylsiloxane Copolymers (Mn=500-80,000), (3-Acryloxy-2-Hydroxypropoxypropyl)methylsiloxane-Dimethylsiloxane Copolymer. (Mn=500-80,000).

Item 13: The method of any of Items 10-12, wherein the radical initiator is selected from the group consisting of dicumyl peroxide (DCP), benzoyl peroxide, 2,4-dichlorobenzoyl peroxide, 1,1′-[1,4-phenylenebis(1-methylethylidene)]bis[2-(1,1-dimethylethyl) peroxide], di-tert-butyl peroxide, tert-butyl cumyl peroxide, tert-butyl peroxybenzoate, Lauroyl peroxide, 2-butanone peroxide, di-tert-butyl peroxide 2,5-di(tert-butylperoxy)-2,5-dimethyl-3-hexyne, 2,5-bis(tert-butylperoxy)-2,5-dimethylhexane.

Item 14: The method of any of Items 10-13, wherein the crosslinking agent is selected from the group consisting of octamethylcyclotetrasiloxane, bis(heptamethylcyclotetrasiloxanyl)-ethane, aliphatic diol, polyvinyl alcohol (n=1-20), trimethylsiloxy-terminated Polydimethylsiloxanes (n=1-20), Alkyl-Terminated Polydimethylsiloxanes (Mn=150-80,000), trimethylsiloxane terminated methylhy drosiloxane-dimethylsiloxane copolymer (Mn=500-80,000), 1,2-Bis(trimethoxysilyl)alkane, Bis[3-(trimethoxysilyl)propyl]amine, Bis(3-(methylamino)propyl)trimethoxy silane.

Items 15: The method of any of Items 10-14, wherein the functionalizing agent and the crosslinking agent are same chemical and the step (a) and step (b) take place at the same time at a temperature between 100° C. and 200° C.

Item 16: The method of any of Items 10-15, wherein the functionalizing agent and the crosslinking agent are the same chemical and said chemical is selected from the group consisting of a siloxane and a silyl ether, wherein the silyl ether or siloxane contains two or more groups selected from the group consisting of a vinyl group, an acrylate group, and a methacrylate group.

Item 17: The method of any of Items 10-16, wherein the functionalizing agent and the crosslinking agent are same chemical, said chemical being selected from the group consisting of 2,4,6,8-Tetramethyl-2,4,6,8-tetravinylcyclotetrasiloxane (D4V), poly (ethylene glycol) silyl ether dimethacrylate (n=1-50), poly (ethylene glycol) silyl ether diacrylate (n=1-50), poly(ethylene glycol) methacrylate (n=1-50), poly(ethylene glycol) acrylate (n=1-50), Vinyl-Terminated Polydimethylsiloxanes (Mn=150-80,000), Vinyl-Terminated Diphenylsiloxane-Dimethylsiloxane Copolymers (Mn=500-80,000), Vinyl-Terminated Polyphenylmethylsiloxane (Mn=500-80,000), Vinylphenylmethyl-Terminated Vinylphenylsiloxane-Phenylmethylsiloxane Copolymer (Mn=800-80,000), Vinyl-Terminated Trifluoropropylmethylsiloxane-Dimethylsiloxane Copolymers (Mn=500-80,000), Vinyl-Terminated Diethylsiloxane-Dimethylsiloxane Copolymers (Mn=500-80,000), Vinylmethylsiloxane-Dimethylsiloxane Copolymers (Mn=500-80,000), Vinylmethylsiloxane Homopolymers (Mn=500-80,000), Polydimethylsiloxane (Mn=150-80,000), Bis(divinyl)-Terminated, Vinylalkoxysiloxane Homopolymer (Mn=500-80,000), Methacryloxypropyl-Terminated Polydimethylsiloxanes (Mn=500-80,000), Methacryloxypropyl-Terminated Branched Poly dimethylsiloxanes (Mn=500-80,000), (3-Acryloxy-2-hydroxypropoxypropyl) Terminated Poly Dimethylsiloxane (Mn=500-80,000), Acryloxy-Terminated Ethyleneoxide-Dimethylsiloxane-Ethyleneoxide ABA Block Copolymers (Mn=500-80,000), (Methacrylate/Acrylate)methylsiloxane-Dimethylsiloxane Copolymers (Mn=500-80,000), (3-Acryloxy-2-Hydroxypropoxypropyl)methylsiloxane-Dimethylsiloxane Copolymer (Mn=500-80,000), (Acryloxypropyl)methylsiloxane-Dimethylsiloxane Copolymers (Mn=500-80,000), (3-Acryloxy-2-Hydroxypropoxypropyl)methylsiloxane-Dimethylsiloxane Copolymer. (Mn=500-80,000).

Item 18: The method of any of Items 10-17, wherein the radical initiators and the functionalizing agents/crosslinkers are dispersed in a resin-based polymer to form a plurality of solid compatibilizer particles, and said plurality of solid compatibilizer particles is added to solid polyolefin particles to form a mixture, said mixture being heated to a temperature 100° C. or above to form the compatibilized polyolefin.

Item 19: The method of any of Items 10-18, wherein the compatibilized polyolefin is further subject to an extrusion or molding process to form different solid forms of compatibilized polyolefin.

Item 20: A composition comprising a radical initiator, a functionalizing agent, and a crosslinking agent.

Item 21: The composition of Item 20, wherein the radical initiator, the functionalizing agent, and the crosslinking agent differ from one another.

Item 22: The composition of Item 20, wherein the functionalizing agent and the crosslinking agent are the same chemical, said chemical being selected from the group consisting of a siloxane and a silyl ether, wherein the silyl ether or siloxane contains two or more groups selected from the group consisting of a vinyl group, an acrylate group, and a methacrylate group.

Item 23: The composition of any of Items 20-22, wherein the functionalizing agent and the crosslinking agent are the same chemical, said chemical being a member selected from the group consisting of 2,4,6,8-Tetramethyl-2,4,6,8-tetravinylcyclotetrasiloxane (D4V), poly (ethylene glycol) silyl ether dimethacrylate (n=1-50), poly (ethylene glycol) silyl ether diacrylate (n=1-50), poly(ethylene glycol) methacrylate (n=1-50), poly(ethylene glycol) acrylate (n=1-50), Vinyl-Terminated Polydimethylsiloxanes (Mn=150-80,000), Vinyl-Terminated Diphenylsiloxane-Dimethylsiloxane Copolymers (Mn=500-80,000), Vinyl-Terminated Polyphenylmethylsiloxane (Mn=500-80,000), Vinylphenylmethyl-Terminated Vinylphenylsiloxane-Phenylmethylsiloxane Copolymer (Mn=800-80,000), Vinyl-Terminated Trifluoropropylmethylsiloxane-Dimethylsiloxane Copolymers (Mn=500-80,000), Vinyl-Terminated Diethylsiloxane-Dimethylsiloxane Copolymers (Mn=500-80,000), Vinylmethylsiloxane-Dimethylsiloxane Copolymers (Mn=500-80,000), Vinylmethylsiloxane Homopolymers (Mn=500-80,000), Polydimethylsiloxane (Mn=150-80,000), Bis(divinyl)-Terminated, Vinylalkoxysiloxane Homopolymer (Mn=500-80,000), Methacryloxypropyl-Terminated Polydimethylsiloxanes (Mn=500-80,000), Methacryloxypropyl-Terminated Branched Polydimethylsiloxanes (Mn=500-80,000), (3-Acryloxy-2-hydroxypropoxypropyl) Terminated PolyDimethylsiloxane (Mn=500-80,000), Acryloxy-Terminated Ethyleneoxide-Dimethylsiloxane-Ethyleneoxide ABA Block Copolymers (Mn=500-80,000), (Methacrylate/Acrylate)methylsiloxane-Dimethylsiloxane Copolymers (Mn=500-80,000), (3-Acryloxy-2-Hydroxypropoxypropyl)methylsiloxane-Dimethylsiloxane Copolymer (Mn=500-80,000), (Acryloxypropyl)methylsiloxane-Dimethylsiloxane Copolymers (Mn=500-80,000), (3-Acryloxy-2-Hydroxypropoxypropyl)methylsiloxane-Dimethylsiloxane Copolymer. (Mn=500-80,000).

Item 24: The composition of any of Items 20-23, wherein the radical initiator is selected from the group consisting of dicumyl peroxide (DCP), benzoyl peroxide, 2,4-dichlorobenzoyl peroxide, 1,1′-[1,4-phenylenebis(1-methylethylidene)]bis[2-(1,1-dimethylethyl) peroxide], di-tert-butyl peroxide, tert-butyl cumyl peroxide, tert-butyl peroxybenzoate, Lauroyl peroxide, 2-butanone peroxide, di-tert-butyl peroxide 2,5-di(tert-butylperoxy)-2,5-dimethyl-3-hexyne, 2,5-bis(tert-butylperoxy)-2,5-dimethylhexane, wherein the functionalizing agent is selected from the group consisting of triethoxyvinylsilane, trimethoxyvinylsilane, allyltriethoxysilane, allyltrimethoxysilane, tris(2-methoxyethoxy)(vinyl)silane, 3-(trimethoxysilyl)alkyl methacrylate, 3-(trimethoxysilyl)alkyl acrylate, 3-(triethoxysilyl)alkyl methacrylate, 3-(triethoxysilyl)alkyl acrylate, poly (ethylene glycol) silyl ether dimethacrylate, poly (ethylene glycol) silyl ether diacrylate, poly(ethylene glycol) methacrylate, poly(ethylene glycol) acrylate, 2,4,6,8-tetravinyl-2,4,6,8-tetramethylcyclotetrasiloxane, Vinyl-Terminated Polydimethylsiloxanes, Vinyl-Terminated Diphenylsiloxane-Dimethylsiloxane Copolymers, Vinyl-Terminated Polyphenylmethylsiloxane, Vinylphenylmethyl-Terminated Vinylphenylsiloxane-Phenylmethylsiloxane Copolymer, Vinyl-Terminated Trifluoropropylmethylsiloxane-Dimethylsiloxane Copolymers, Diethylsiloxane-Dimethylsiloxane Copolymers (Vinyl-Terminated), Vinylmethylsiloxane-Dimethylsiloxane Copolymers, Vinylmethylsiloxane-Dimethylsiloxane Copolymers, Vinylmethylsiloxane Homopolymers, Polydimethylsiloxane, Bis(divinyl)-Terminated, Vinylalkoxysiloxane Homopolymer, Methacryloxypropyl-Terminated Polydimethylsiloxanes, Methacryloxypropyl-Terminated Branched Polydimethylsiloxanes, (3-Acryloxy-2-hydroxypropoxypropyl) Terminated PolyDimethylsiloxane, Acryloxy-Terminated Ethyleneoxide-Dimethylsiloxane-Ethyleneoxide ABA Block Copolymers, (Methacrylate/Acrylate)methylsiloxane-Dimethylsiloxane Copolymers, (3-Acryloxy-2-Hydroxypropoxypropyl)methylsiloxane-Dimethylsiloxane Copolymer, (Acryloxypropyl)methylsiloxane-Dimethylsiloxane Copolymers, (3-Acryloxy-2-Hydroxypropoxypropyl)methylsiloxane-Dimethylsiloxane Copolymer, and wherein the crosslinking agent is selected from the group consisting of octamethylcyclotetrasiloxane, bis(heptamethylcyclotetrasiloxanyl)-ethane, aliphatic diol, polyvinyl alcohol, trimethylsiloxy-terminated Polydimethylsiloxanes, Alkyl-Terminated Polydimethylsiloxanes, trimethyldiloxane terminated methylhydrosiloxane-dimethylsiloxane copolymer, 1,2-Bis(trimethoxysilyl)alkane, Bis[3-(trimethoxysilyl)propyl]amine, Bis(3-(methylamino)propyl)trimethoxysilane.

Item 25: The composition of any of Items 20-24, wherein the radical initiator, the functionalizing agent, and the crosslinking agent constitute active ingredients of the composition, wherein said active ingredients are dispersed in a resin-based polymer to form solid particles.

Item 26: The composition of Item 25, wherein the resin-based polymer further comprises one or more additives, said one or more additives being selected from the group consisting of UV-stabilizers, antistatic and slip agents, antiblock, impact modifiers, processing aids, and melt strength enhancers.

Item 27: The composition of any of Items 25-26, wherein the weight ratio between the active ingredients and the resin-based polymer is more than 30%, or more than 50%, or more than 90%, or more than 99%.

Item 28: A method of reusing plastics by converting recycled plastics into the polyolefin composition of Item 1.

Item 29: The method of Item 29, further comprising making a product by using the polyolefin composition of Item 1.

### EXAMPLES

The following examples are provided to illustrate specific embodiments of the current disclosure and to demonstrate the features and advantages of the embodiments but are not intended to limit the scope thereof. Instead, the examples guide one of ordinary skill in the art in understanding and applying the inventive concepts of the disclosure.

The following materials were used: Polyethylene, high density, melt index 12 g/10 min (190° C./2.16 Kg), Sigma-Aldrich; Polypropylene, isotactic, average Mw~190,000, average Mn~50,000, Sigma-Aldrich; Polystyrene, average Mw~192,000, Sigma-Aldrich; vinyltriethoxysilane (TEVS), Gelest; Dicumyl peroxide (DCP), Sigma-Aldrich; 2,4,6,8-tetravinyl-2,4,6,8-tetramethylcyclotetrasiloxane (D4V), Gelest, Vinyl Terminated Polydimethylsiloxane, Gelest; CDCl₃, Sigma-Aldrich; Tetrahydrofuran (THF), inhibitor-free, Fisher.

¹H-NMR and ¹³C-NMR spectra were obtained on a Burker-300 Ultrashield NMR instrument. Fourier transform Infrared (FT-IR) spectra were obtained on Agilent Cary 630 FTIR spectrometer. Scanning Electron Microscopy images (SEM) were recorded using a JSM-6480LV (LVSEM) at 30 kV. The mechanical properties (tensile modulus, strength, and elongation) of the polymers were evaluated by uniaxial tensile tests using Instron 5965.

### Example 1

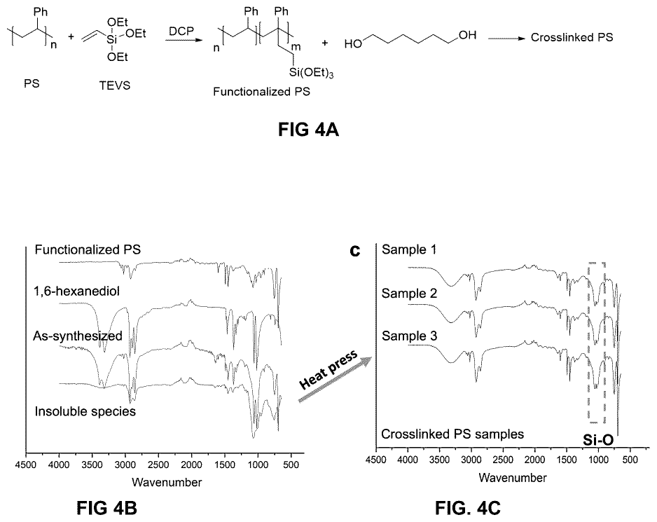

Method A (FIG. 4): PS was ground into fine particles (size ~1 mm). DCP and TEVS (1:10 weight ratio) was mixed to form a clear solution. The solution (10 wt % of the amount of PS) was mixed with PS particles. The mixture was placed in between two pieces of polytetrafluoroethylene (PTFE) paper and heat-pressed at 180° C. for 15 min at a minimal pressure to form the functionalized PS. The functionalized PS was completely soluble in THF and a clear homogeneous solution without any noticeable insoluble species was formed. The diol (10 wt % of the amount of PS) was added and all the volatiles were removed under vacuum. The solid was heat pressed at 180° C. for 15 min at a minimal pressure to form the as-synthesized crosslinked PS (labeled as “as-synthesized” in FIG. 4B). The as-synthesized crosslinked PS was soaked in THF and insoluble species were collected, dried, and heat pressed. The IR spectrum of the as-synthesized sample showed the 1,6-hexanediol absorption peak. The IR spectrum of the insoluble species obtained after soaking did not show the residual 1,6-hexanediol absorption. The IR spectra of the samples (multiple samples collected) showed Si—O absorption peak and also O—H stretching absorption peak. These results demonstrated that if suitable reaction temperature, pressure, and time are applied, the two-step crosslinking may be successful under compression molding conditions.

### Example 2

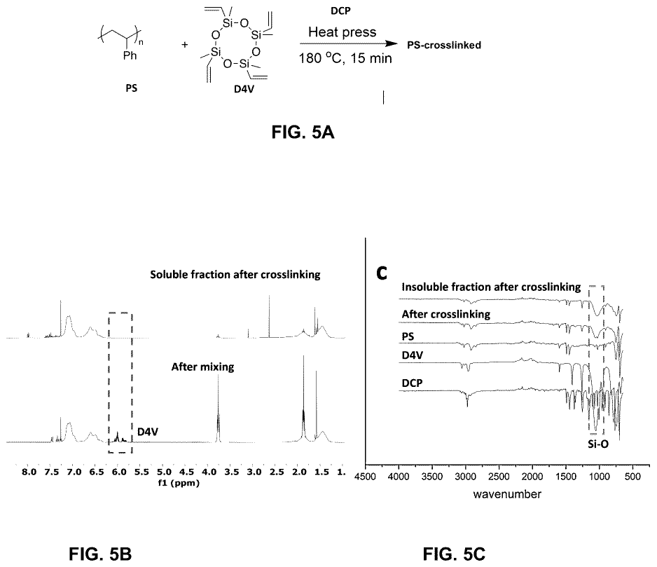

Method B (FIG. 5): PS was ground into fine particles (size ~1 mm). DCP and D4V (1:10 weight ratio) was mixed to form a clear solution, which can be used as a compatibilizer in later cases. The solution was mixed with PS particles. The mixture was placed in between two pieces of PTFE paper and heat-pressed at 180° C. for 15 min at a minimal pressure to form the crosslinked PS. The amount of the compatibilizer solution added to PS was varied from 1.25 wt % to 50 wt %. The gel fraction after crosslinking ranged from 5% to 50%. The crosslinked PS prepared using 50 wt % compatibilizer was dissolved in CDCl₃, and the insoluble fraction and soluble fraction were separated. The ¹H NMR spectrum of the soluble fraction shows the absence of D4V and the presence of the trace amount of decomposed DCP, indicating successful reaction of D4V with PS. The ¹H NMR spectrum of the mixture before heat pressing shows the proton signals of D4V and DCP. The IR spectra of the PS mixture after crosslinking and the insoluble fraction are nearly identical and showed the absorption peaks of PS components and Si—O stretching. These results demonstrated the successful incorporation of Si—O bonds into PS through compression molding method. A shorter processing time was also explored, and it was discovered that 3 min may be sufficient for such reaction.

### Example 3

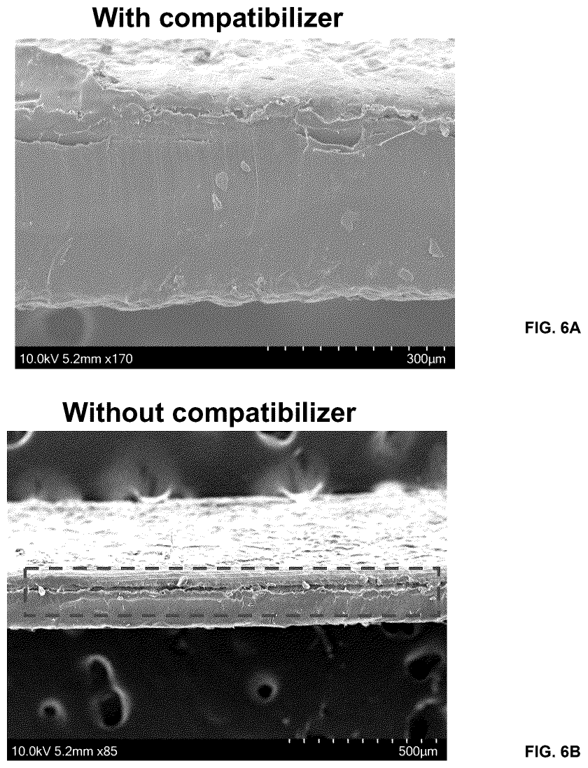

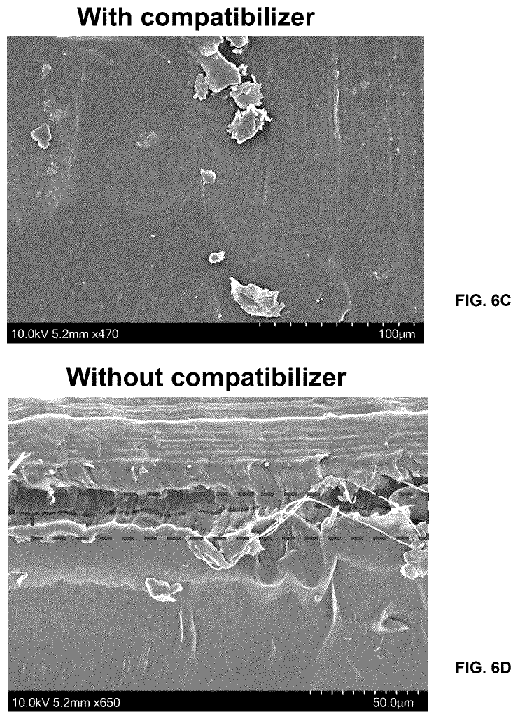

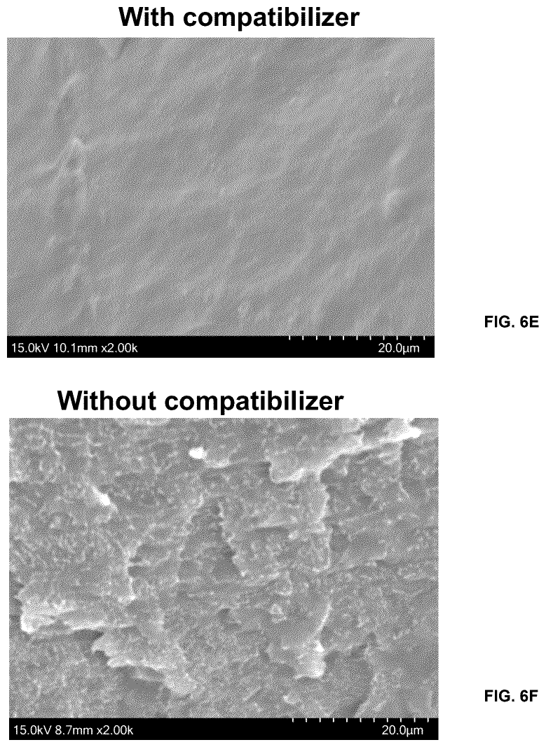

Commercial PE pellets were heat pressed (180° C., 5 seconds) to form a PE film. Commercial PP pellets were heat pressed (180° C., 5 seconds) to form a PP film. DCP and D4V (1:10 weight ratio) was mixed to form a clear solution and used as a compatibilizer. The compatibilizer solution was drop casted onto the surface of PE and PP films. The two films (1:1 weight ratio) were stacked together with the compatibilizer in between the two films and heat pressed at 180° C. for 3 min. As a control sample, two PE and PP films were stacked, and heat pressed at 180° C. for 3 min without adding any compatibilizer solution. The strong adhesion between PP/PE interface was achieved with the compatibilizer. The sample with the compatibilizer behaved similar to the commercial PE or PP and elongated more than 6 times of the original length, whereas the sample without the compatibilizer was brittle and had elongation at break <0.5%. The SEM images (FIG. 6A, FIG. 6B, FIG. 6C, and FIG. 6D) of the cross section of the sample showed that the sample prepared with the compatibilizer had seamless cross section, indicating good interface adhesion. The sample prepared without the compatibilizer showed obvious visible voids between PP and PE films, showing poor interface adhesion and incompatibility.

### Example 4

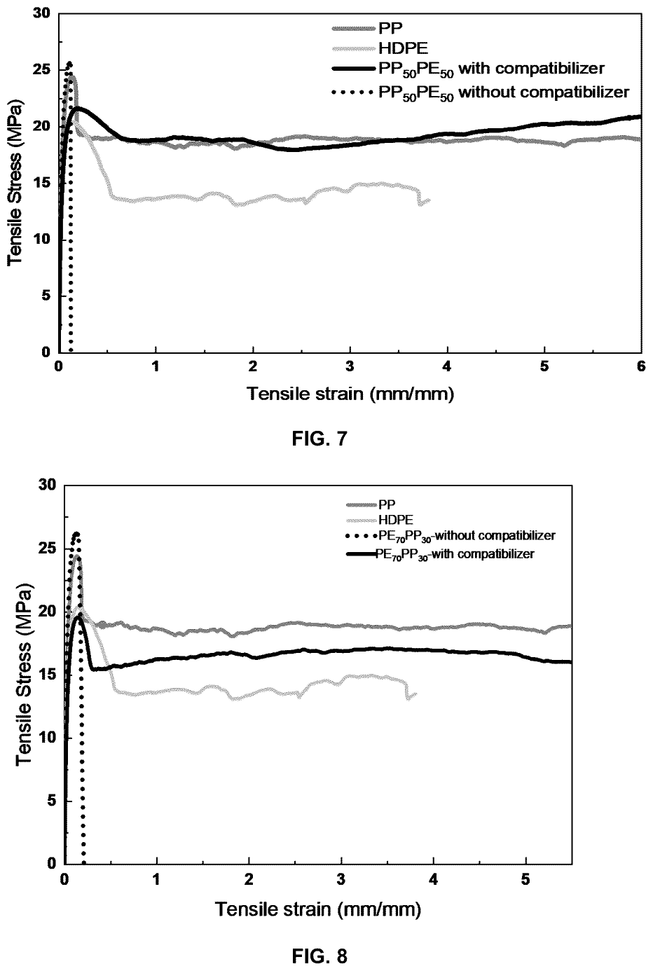

The PE and PP were ground into fine particles (particle size ~1 mm). DCP was dissolved in D4V to form a compatibilizer solution. A mixture of PP and PE particles in 50:50 weight ratio was mixed with the compatibilizer solution (10 wt % of the total amount of PE and PP). The mixture was heat-pressed at 180° C. for 3 min to form a film. The temperature and pressing time were screened. 170° C. for 5 min or 180° C. for 3 min were sufficient to obtain films with good mechanical properties. For each trial, multiple samples were tested, and the representative tensile curves are shown in FIG. 7.

### Example 5

The PE and PP was ground into fine particles (particle size ~1 mm). DCP was dissolved in D4V to form a compatibilizer solution. A mixture of PE and PP in 70:30 weight ratio was mixed with the compatibilizer solution (1 wt % of the total amount of PE and PP). The mixture was heat pressed at 180° C. for 3 min to form a film. The temperature and pressing time were screened. For each trial, multiple samples were tested, and the representative tensile curves are shown in FIG. 8.

### Example 6

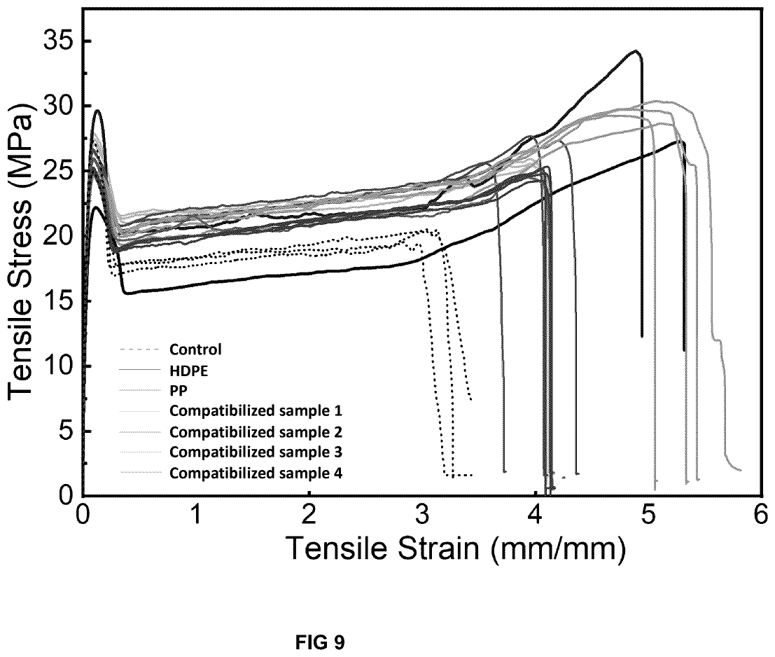

Commercial PE and PP pellets in a 70:30 weight ratio were mixed with a compatibilizer mixture. For Compatibilized sample 1 and 3 (FIG. 9), the compatibilizer mixtures were prepared by mixing DCP and vinyl terminated polydimethyl siloxanes of different molecular weights. For Compatibilized sample 2 and 4 the compatibilizer mixture was prepared by mixing DCP and vinyl terminated polydimethyl siloxane with a LDPE carrier resin (77 wt % of the total compatibilizer mixture). A compatibilizer mixture consisting of carrier resins was referred as a masterbatch in some embodiments. The control sample was also prepared from commercial HDPE and PP in a 70:30 weight ratio without the compatibilizer mixture. HDPE and PP samples were prepared from the commercial PE and PP for the comparison reasons. For Compatibilized sample 1 and 3, 1 wt % of the compatibilizer mixture was added. For Compatibilized sample 2 and 4, 3 wt % of the compatibilizer mixture was added. All the samples were prepared through an extrusion and subsequent injection molding into a dog-bone shape with a thickness of 2 mm and length of 50 mm. The materials were extruded with a mixing speed of 25 rpm, and zone temperatures of 150/180/180° C. Subsequent injection molding of the materials was followed at 200° C. with a mold temperature of 40° C. The tensile stress-strain curves of all the samples are shown in FIG. 9. Significant improvement of both tensile yield strength and elongation at break (fracture strain) were observed for all the compatibilized samples compared to the control sample without compatibilization. The SEM images of the fracture surface of the Control sample (FIG. 6F) and the Compatibilized sample 1 (FIG. 6E) are shown in FIG. 6. The non-compatibilized control sample shows sharp edges of the particles on the fracture surface and coarse morphology, indicating poor adhesion at the interface and incompatibility (FIG. 6F). On the contrary, the blends with a compatibilizer (for example, FIG. 6E) show a more homogeneous morphology and the distinction between phases was barely detectable, indicating low interface tension and good compatibility.

1. A polyolefin composition comprising a first component, a second component and a third component,
the first component comprising a polymer selected from the group consisting of one or more polyethylenes (PE), one or more polypropylenes (PP) and one or more polystyrenes (PS),
the second component comprising a polymer selected from the group consisting of one or more polyethylenes, one or more polypropylenes and one or more polystyrenes (PS), and
the third component being a covalent crosslink,
wherein said covalent crosslink connects the first component and the second component, and said covalent crosslink is selected from the group consisting of siloxane bond (Si—O—Si), silyl ether bond (Si—O—C) and combination thereof.

2. (canceled)

3. The polyolefin composition of claim 1, wherein the first component and the second component are different, the first component being one or more polyethylenes and the second component being selected from the group consisting of one or more polypropylenes and one or more polystyrenes.

4. The polyolefin composition of claim 1, wherein the first component and the second component are different, the first component being one or more polypropylenes and the second component being selected from the group consisting of one or more polyethylenes and one or more polystyrenes.

5. The polyolefin composition of claim 1, wherein the first component and the second component comprise the same type of polymer selected from the group consisting of polyethylenes (PE), polypropylenes (PP) and polystyrenes (PS).

6. The polyolefin composition of claim 1, wherein the silyl ether or siloxane bonds undergo dynamic bond exchange reactions within the same polymer chain or between different polymer chains of the first component or the second component.

7. A multi-layer sheet comprising
a first layer comprising polyethylene;
a second layer comprising polypropylene; and
a third layer, wherein the third layer is an adhesion layer comprising a covalent crosslink connecting the polyethylene of the first layer and the polypropylene of the second layer, said covalent crosslink being selected from the group consisting of siloxane bond (Si—O—Si), silyl ether bond (Si—O—C) and combination thereof,
wherein the adhesion layer is disposed between the first layer and the second layer, and is in direct contact with the first layer and the second layer.

8. The multi-layer sheet according to claim 7, wherein the polyethylene in the first layer is selected from the group consisting of: high density polyethylene (HDPE), low density polyethylene (LDPE), linear low-density polyethylene (LLDPE), ultra-high molecular weight polyethylene (UHMWPE), very low-density polyethylene (VLDPE), and polyethylene polyolefin block copolymer, and wherein the polypropylene in the second layer is selected from the group consisting of: isotactic polypropylene (iPP), impact modified polypropylene, polypropylene fibers, and biaxially oriented polypropylene (BOPP).

9. (canceled)

10. A method for making a polyolefin composition of claim 1, comprising
a) mixing a polyolefin with a functionalizing agent and a radical initiator, allowing the polyolefin to react with the functionalizing agent in the presence of the radical initiator to form a functionalized polyolefin, and
b) adding a crosslinking agent to the functionalized polyolefin from step (a), allowing the functionalized polyolefin to react with the crosslinking agent to form the compatibilized polyolefin.

11. (canceled)

12. The method of claim 10, wherein the functionalizing agent is selected from the group consisting of triethoxyvinylsilane (TEVS), trimethoxyvinylsilane, allyltriethoxysilane, allyltrimethoxysilane, tris(2-methoxyethoxy)(vinyl)silane, 3-(trimethoxysilyl)alkyl methacrylate, 3-(trimethoxysilyl)alkyl acrylate, 3-(triethoxysilyl)alkyl methacrylate, 3-(triethoxysilyl)alkyl acrylate, poly (ethylene glycol) silyl ether dimethacrylate (n=1-50), poly (ethylene glycol) silyl ether diacrylate (n=1-50), poly(ethylene glycol) methacrylate (n=1-50), poly(ethylene glycol) acrylate (n=1-50), 2,4,6,8-tetravinyl-2,4,6,8-tetramethylcyclotetrasiloxane, Vinyl-Terminated Polydimethylsiloxanes (Mn=150-80,000), Vinyl-Terminated Diphenylsiloxane-Dimethylsiloxane Copolymers (Mn=500-80,000), Vinyl-Terminated Polyphenylmethylsiloxane (Mn=500-80,000), Vinylphenylmethyl-Terminated Vinylphenylsiloxane-Phenylmethylsiloxane Copolymer (Mn=800-80,000), Vinyl-Terminated Trifluoropropylmethylsiloxane-Dimethylsiloxane Copolymers (Mn=500-80,000), Vinyl-Terminated Diethylsiloxane-Dimethylsiloxane Copolymers (Mn=500-80,000), Vinylmethylsiloxane-Dimethylsiloxane Copolymers (Mn=500-80,000), Vinylmethylsiloxane Homopolymers (Mn=500-80,000), Polydimethylsiloxane (Mn=150-80,000), Bis(divinyl)-Terminated, Vinylalkoxysiloxane Homopolymer (Mn=500-80,000), Methacryloxypropyl-Terminated Polydimethylsiloxanes (Mn=500-80,000), Methacryloxypropyl-Terminated Branched Polydimethylsiloxanes (Mn=500-80,000), (3-Acryloxy-2-hydroxypropoxypropyl) Terminated PolyDimethylsiloxane (Mn=500-80,000), Acryloxy-Terminated Ethyleneoxide-Dimethylsiloxane-Ethyleneoxide ABA Block Copolymers (Mn=500-80,000), (Methacrylate/Acrylate)methylsiloxane-Dimethylsiloxane Copolymers (Mn=500-80,000), (3-Acryloxy-2-Hydroxypropoxypropyl)methylsiloxane-Dimethylsiloxane Copolymer (Mn=500-80,000), (Acryloxypropyl)methylsiloxane-Dimethylsiloxane Copolymers (Mn=500-80,000), (3-Acryloxy-2-Hydroxypropoxypropyl)methylsiloxane-Dimethylsiloxane Copolymer. (Mn=500-80,000).

13. The method of claim 10, wherein the radical initiator is selected from the group consisting of dicumyl peroxide (DCP), benzoyl peroxide, 2,4-dichlorobenzoyl peroxide, 1,1′-[1,4-phenylenebis(1-methylethylidene)]bis[2-(1,1-dimethylethyl) peroxide], di-tert-butyl peroxide, tert-butyl cumyl peroxide, tert-butyl peroxybenzoate, Lauroyl peroxide, 2-butanone peroxide, di-tert-butyl peroxide 2,5-di(tert-butylperoxy)-2,5-dimethyl-3-hexyne, 2,5-bis(tert-butylperoxy)-2,5-dimethylhexane.

14. The method of claim 10, wherein the crosslinking agent is selected from the group consisting of octamethylcyclotetrasiloxane, bis(heptamethylcyclotetrasiloxanyl)-ethane, aliphatic diol, polyvinyl alcohol (n=1-20), trimethylsiloxy-terminated Polydimethylsiloxanes (n=1-20), Alkyl-Terminated Polydimethylsiloxanes (Mn=150-80,000), trimethylsiloxane terminated methylhydrosiloxane-dimethylsiloxane copolymer (Mn=500-80,000), 1,2-Bis(trimethoxysilyl)alkane, Bis[3-(trimethoxysilyl)propyl]amine, Bis(3-(methylamino)propyl)trimethoxysilane.

15. (canceled)

16. (canceled)

17. The method of claim 15, wherein the functionalizing agent and the crosslinking agent are same chemical, said chemical being selected from the group consisting of 2,4,6,8-Tetramethyl-2,4,6,8-tetravinylcyclotetrasiloxane (D4V), poly (ethylene glycol) silyl ether dimethacrylate (n=1-50), poly (ethylene glycol) silyl ether diacrylate (n=1-50), poly(ethylene glycol) methacrylate (n=1-50), poly(ethylene glycol) acrylate (n=1-50), Vinyl-Terminated Polydimethylsiloxanes (Mn=150-80,000), Vinyl-Terminated Diphenylsiloxane-Dimethylsiloxane Copolymers (Mn=500-80,000), Vinyl-Terminated Polyphenylmethylsiloxane (Mn=500-80,000), Vinylphenylmethyl-Terminated Vinylphenylsiloxane-Phenylmethylsiloxane Copolymer (Mn=800-80,000), Vinyl-Terminated Trifluoropropylmethylsiloxane-Dimethylsiloxane Copolymers (Mn=500-80,000), Vinyl-Terminated Diethylsiloxane-Dimethylsiloxane Copolymers (Mn=500-80,000), Vinylmethylsiloxane-Dimethylsiloxane Copolymers (Mn=500-80,000), Vinylmethylsiloxane Homopolymers (Mn=500-80,000), Polydimethylsiloxane (Mn=150-80,000), Bis(divinyl)-Terminated, Vinylalkoxysiloxane Homopolymer (Mn=500-80,000), Methacryloxypropyl-Terminated Polydimethylsiloxanes (Mn=500-80,000), Methacryloxypropyl-Terminated Branched Polydimethylsiloxanes (Mn=500-80,000), (3-Acryloxy-2-hydroxypropoxypropyl) Terminated PolyDimethylsiloxane (Mn=500-80,000), Acryloxy-Terminated Ethyleneoxide-Dimethylsiloxane-Ethyleneoxide ABA Block Copolymers (Mn=500-80,000), (Methacrylate/Acrylate)methylsiloxane-Dimethylsiloxane Copolymers (Mn=500-80,000), (3-Acryloxy-2-Hydroxypropoxypropyl)methylsiloxane-Dimethylsiloxane Copolymer (Mn=500-80,000), (Acryloxypropyl)methylsiloxane-Dimethylsiloxane Copolymers (Mn=500-80,000), (3-Acryloxy-2-Hydroxypropoxypropyl)methylsiloxane-Dimethylsiloxane Copolymer. (Mn=500-80,000).

18. The method of claim 16, wherein the radical initiators and the functionalizing agents/crosslinkers are dispersed in a resin-based polymer to form a plurality of solid compatibilizer particles, and said plurality of solid compatibilizer particles is added to solid polyolefin particles to form a mixture, said mixture being heated to a temperature 100° C. or above to form the compatibilized polyolefin.

19. (canceled)

20. A composition comprising a radical initiator, a functionalizing agent, and a crosslinking agent.

21. The composition of claim 20, wherein the radical initiator, the functionalizing agent, and the crosslinking agent differ from each other.

22. (canceled)

23. The composition of claim 20, wherein the functionalizing agent and the crosslinking agent are the same chemical, said chemical being a member selected from the group consisting of 2,4,6,8-Tetramethyl-2,4,6,8-tetravinylcyclotetrasiloxane (D4V), poly (ethylene glycol) silyl ether dimethacrylate (n=1-50), poly (ethylene glycol) silyl ether diacrylate (n=1-50), poly(ethylene glycol) methacrylate (n=1-50), poly(ethylene glycol) acrylate (n=1-50), Vinyl-Terminated Polydimethylsiloxanes (Mn=150-80,000), Vinyl-Terminated Diphenylsiloxane-Dimethylsiloxane Copolymers (Mn=500-80,000), Vinyl-Terminated Polyphenylmethylsiloxane (Mn=500-80,000), Vinylphenylmethyl-Terminated Vinylphenylsiloxane-Phenylmethylsiloxane Copolymer (Mn=800-80,000), Vinyl-Terminated Trifluoropropylmethylsiloxane-Dimethylsiloxane Copolymers (Mn=500-80,000), Vinyl-Terminated Diethylsiloxane-Dimethylsiloxane Copolymers (Mn=500-80,000), Vinylmethylsiloxane-Dimethylsiloxane Copolymers (Mn=500-80,000), Vinylmethylsiloxane Homopolymers (Mn=500-80,000), Polydimethylsiloxane (Mn=150-80,000), Bis(divinyl)-Terminated, Vinylalkoxysiloxane Homopolymer (Mn=500-80,000), Methacryloxypropyl-Terminated Polydimethylsiloxanes (Mn=500-80,000), Methacryloxypropyl-Terminated Branched Polydimethylsiloxanes (Mn=500-80,000), (3-Acryloxy-2-hydroxypropoxypropyl) Terminated PolyDimethylsiloxane (Mn=500-80,000), Acryloxy-Terminated Ethyleneoxide-Dimethylsiloxane-Ethyleneoxide ABA Block Copolymers (Mn=500-80,000), (Methacrylate/Acrylate)methylsiloxane-Dimethylsiloxane Copolymers (Mn=500-80,000), (3-Acryloxy-2-Hydroxypropoxypropyl)methylsiloxane-Dimethylsiloxane Copolymer (Mn=500-80,000), (Acryloxypropyl)methylsiloxane-Dimethylsiloxane Copolymers (Mn=500-80,000), (3-Acryloxy-2-Hydroxypropoxypropyl)methylsiloxane-Dimethylsiloxane Copolymer. (Mn=500-80,000).

24. The composition of claim 20, wherein the radical initiator is selected from the group consisting of dicumyl peroxide (DCP), benzoyl peroxide, 2,4-dichlorobenzoyl peroxide, 1,1′-[1,4-phenylenebis(1-methylethylidene)]bis[2-(1,1-dimethylethyl) peroxide], di-tert-butyl peroxide, tert-butyl cumyl peroxide, tert-butyl peroxybenzoate, Lauroyl peroxide, 2-butanone peroxide, di-tert-butyl peroxide 2,5-di(tert-butylperoxy)-2,5-dimethyl-3-hexyne, 2,5-bis(tert-butylperoxy)-2,5-dimethylhexane, wherein the functionalizing agent is selected from the group consisting of triethoxyvinylsilane, trimethoxyvinylsilane, allyltriethoxysilane, allyltrimethoxysilane, tris(2-methoxyethoxy)(vinyl)silane, 3-(trimethoxysilyl)alkyl methacrylate, 3-(trimethoxysilyl)alkyl acrylate, 3-(triethoxysilyl)alkyl methacrylate, 3-(triethoxysilyl)alkyl acrylate, poly (ethylene glycol) silyl ether dimethacrylate, poly (ethylene glycol) silyl ether diacrylate, poly(ethylene glycol) methacrylate, poly(ethylene glycol) acrylate, 2,4,6,8-tetravinyl-2,4,6,8-tetramethylcyclotetrasiloxane, Vinyl-Terminated Polydimethylsiloxanes, Vinyl-Terminated Diphenylsiloxane-Dimethylsiloxane Copolymers, Vinyl-Terminated Polyphenylmethylsiloxane, Vinylphenylmethyl-Terminated Vinylphenylsiloxane-Phenylmethylsiloxane Copolymer, Vinyl-Terminated Trifluoropropylmethylsiloxane-Dimethylsiloxane Copolymers, Diethylsiloxane-Dimethylsiloxane Copolymers (Vinyl-Terminated), Vinylmethylsiloxane-Dimethylsiloxane Copolymers, Vinylmethylsiloxane-Dimethylsiloxane Copolymers, Vinylmethylsiloxane Homopolymers, Polydimethylsiloxane, Bis(divinyl)-Terminated, Vinylalkoxysiloxane Homopolymer, Methacryloxypropyl-Terminated Polydimethylsiloxanes, Methacryloxypropyl-Terminated Branched Polydimethylsiloxanes, (3-Acryloxy-2-hydroxypropoxypropyl) Terminated PolyDimethylsiloxane, Acryloxy-Terminated Ethyleneoxide-Dimethylsiloxane-Ethyleneoxide ABA Block Copolymers, (Methacrylate/Acrylate)methylsiloxane-Dimethylsiloxane Copolymers, (3-Acryloxy-2-Hydroxypropoxypropyl)methylsiloxane-Dimethylsiloxane Copolymer, (Acryloxypropyl)methylsiloxane-Dimethylsiloxane Copolymers, (3-Acryloxy-2-Hydroxypropoxypropyl)methylsiloxane-Dimethylsiloxane Copolymer, and
wherein the crosslinking agent is selected from the group consisting of octamethylcyclotetrasiloxane, bis(heptamethylcyclotetrasiloxanyl)-ethane, aliphatic diol, polyvinyl alcohol, trimethylsiloxy-terminated Polydimethylsiloxanes, Alkyl-Terminated Polydimethylsiloxanes, trimethyldiloxane terminated methylhydrosiloxane-dimethylsiloxane copolymer, 1,2-Bis(trimethoxysilyl)alkane, Bis[3-(trimethoxysilyl)propyl]amine, Bis(3-(methylamino)propyl)trimethoxysilane.

25. The composition of claim 20, wherein the radical initiator, the functionalizing agent, and the crosslinking agent constitute active ingredients of the composition, wherein said active ingredients are dispersed in a resin-based polymer to form solid particles.

26. The composition of claim 25, wherein the resin-based polymer further comprises one or more additives, said one or more additives being selected from the group consisting of UV-stabilizers, antistatic and slip agents, antiblock, impact modifiers, processing aids, and melt strength enhancers.

27. (canceled)

28. A method of reusing plastics by converting recycled plastics into the polyolefin composition of claim 1.

29. (canceled)
